(19) United States
(12) Patent Application Publication
(10) Pub. No.: US 2025/0088927 A1
(43) Pub. Date: Mar. 13, 2025

(54) LOWER LAYER TRIGGERED MOBILITY TO A CELL SUPPORTING MULTIPLE TRPS

(71) Applicant: Samsung Electronics Co., Ltd., Suwon-si (KR)

(72) Inventors: Anil Agiwal, Allen, TX (US); Shiyang Leng, Allen, TX (US); Kyeongin Jeong, Allen, TX (US)

(21) Appl. No.: 18/818,375

(22) Filed: Aug. 28, 2024

Related U.S. Application Data
(60) Provisional application No. 63/538,018, filed on Sep. 12, 2023.
(60) Provisional application No. 63/677,193, filed on Jul. 30, 2024.

(51) Int. Cl. H04W 36/08; H04W 36/00

(52) U.S. Cl. CPC H04W 36/08; H04W 36/0069

(57) ABSTRACT

A user equipment (UE) includes a transceiver configured to receive a radio resource control (RRC) reconfiguration message including a configuration of a lower layer triggered mobility (LTM) candidate cell, and receive an LTM cell switch command instructing the UE to perform an LTM cell switch to the LTM candidate cell. The UE also includes a processor operably coupled to the transceiver. The processor is configured to determine whether the LTM candidate cell belongs to a master cell group (MCG), and determine whether the configuration of the LTM candidate cell includes a system information block 1 (SIB1). The transceiver is also configured to, when the LTM candidate cell belongs to the MCG and the configuration of the LTM candidate cell includes the SIB1, transmit a system information (SI) request to the LTM candidate cell after the LTM cell switch to the LTM candidate cell is successfully completed.

### CROSS-REFERENCE TO RELATED APPLICATION(S) AND CLAIM OF PRIORITY

This application claims priority under 35 U.S.C. § 119(e) to U.S. Provisional Patent Application No. 63/538,018 filed on Sep. 12, 2023, and U.S. Provisional Patent Application No. 63/677,193 filed on Jul. 30, 2024. The above-identified provisional patent applications are hereby incorporated by reference in their entirety.

### TECHNICAL FIELD

This disclosure relates generally to wireless networks. More specifically, this disclosure relates to lower layer triggered mobility to a cell supporting multiple transmit receive points (TRPs).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods of lower layer triggered mobility to a cell supporting multiple TRPs.

In one embodiment, a user equipment (UE) is provided. The UE includes a transceiver configured to receive a radio resource control (RRC) reconfiguration message including a configuration of a lower layer triggered mobility (LTM) candidate cell, and receive an LTM cell switch command instructing the UE to perform an LTM cell switch to the LTM candidate cell. The UE also includes a processor operably coupled to the transceiver. The processor is configured to determine whether the LTM candidate cell belongs to a master cell group (MCG), and determine whether the configuration of the LTM candidate cell includes a system information block 1 (SIB1). The transceiver is also configured to, when the LTM candidate cell belongs to the MCG and the configuration of the LTM candidate cell includes the SIB1, transmit a system information (SI) request to the LTM candidate cell after the LTM cell switch to the LTM candidate cell is successfully completed.

In another embodiment, a method of operating a UE is provided. The method includes receiving a radio resource control (RRC) reconfiguration message including a configuration of a lower layer triggered mobility (LTM) candidate cell, and receiving an LTM cell switch command instructing the UE to perform an LTM cell switch to the LTM candidate cell. The method also includes determining whether the LTM candidate cell belongs to an MCG, and determining whether the configuration of the LTM candidate cell includes a SIB1. The method also includes, when the LTM candidate cell belongs to the MCG and the configuration of the LTM candidate cell includes the SIB1, transmitting an SI request to the LTM candidate cell after the LTM cell switch to the LTM candidate cell is successfully completed.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for lower layer triggered mobility 400 according to embodiments of the present disclosure;

FIG. 5 illustrates an example procedure for lower layer triggered mobility to a cell supporting multiple TRPs/TAGs according to embodiments of the present disclosure;

FIG. 6 illustrates another example procedure for lower layer triggered mobility to a cell supporting multiple TRPs/TAGs according to embodiments of the present disclosure;

FIG. 7 illustrates another example procedure for lower layer triggered mobility to a cell supporting multiple TRPs/TAGs according to embodiments of the present disclosure;

FIG. 8 illustrates another example procedure for lower layer triggered mobility to a cell supporting multiple TRPs/TAGs according to embodiments of the present disclosure;

FIG. 9 illustrates another example procedure for lower layer triggered mobility to a cell supporting multiple TRPs/TAGs according to embodiments of the present disclosure;

FIG. 10 illustrates another example procedure for lower layer triggered mobility to a cell supporting multiple TRPs/TAGs according to embodiments of the present disclosure;

FIG. 11 illustrates an example procedure for lower layer triggered mobility according to embodiments of the present disclosure; and

FIG. 12 illustrates an example method of lower layer triggered mobility to a cell supporting multiple TRPs according to embodiments of the present disclosure.

### DETAILED DESCRIPTION

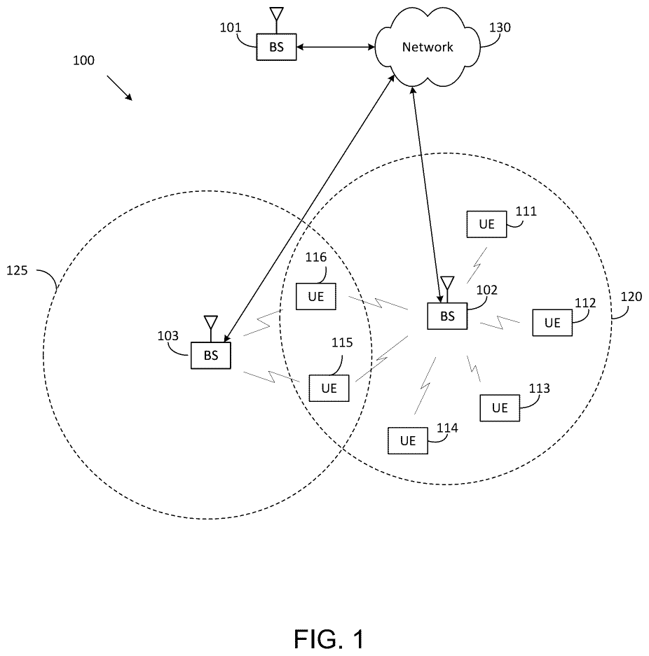

FIGS. 1 through 12, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for lower layer triggered mobility to a cell supporting multiple TRPs. In certain embodiments, one or more of the gNBs 101-103 includes circuitry, programing, or a combination thereof, to support lower layer triggered mobility to a cell supporting multiple TRPs in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

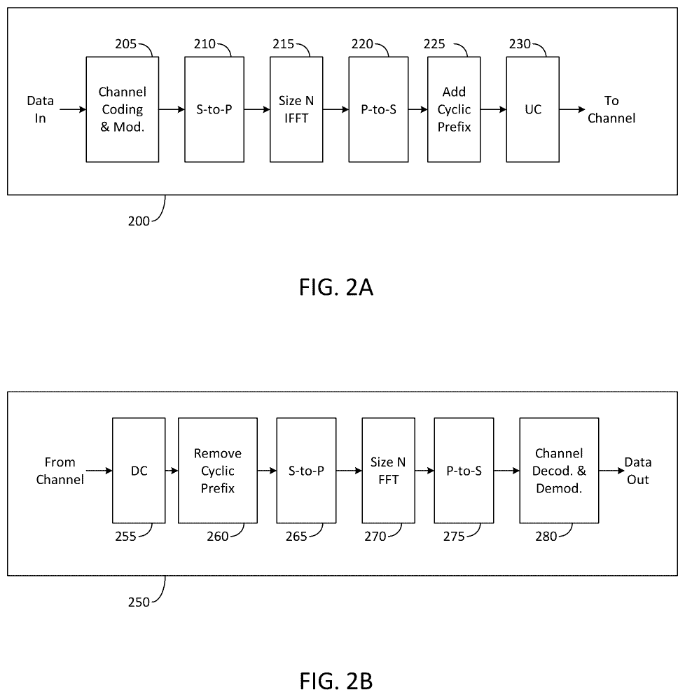

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support lower layer triggered mobility to a cell supporting multiple TRPs as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

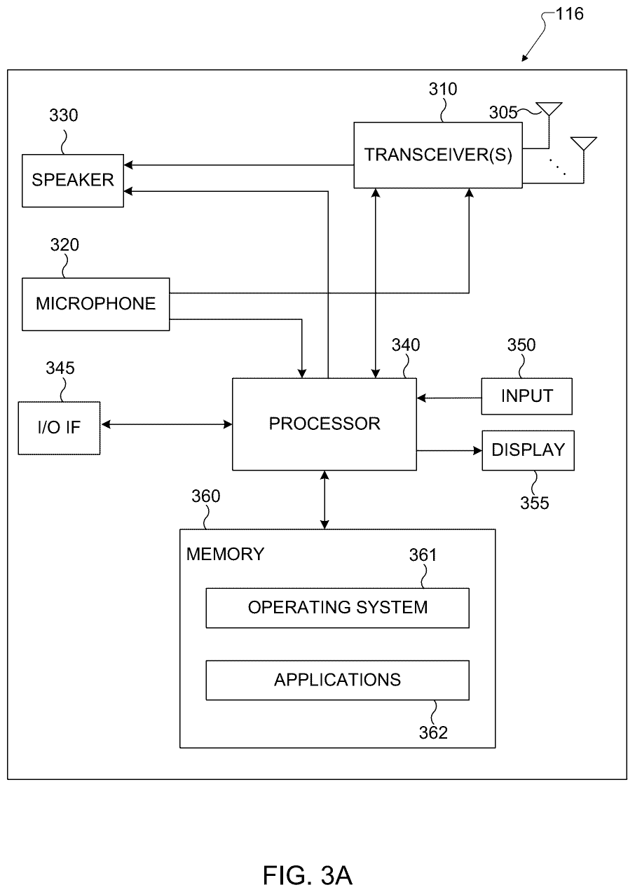

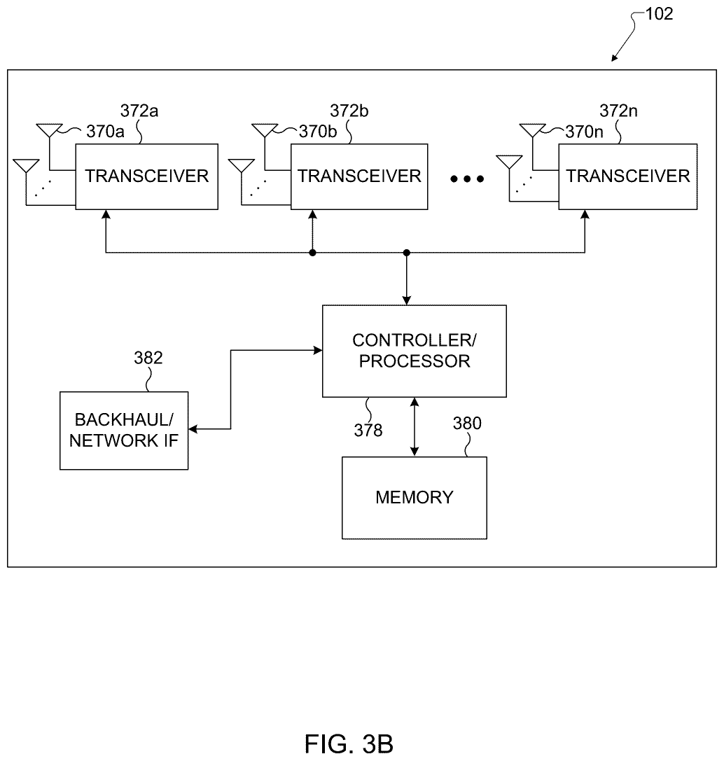

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for lower layer triggered mobility to a cell supporting multiple TRPs as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support lower layer triggered mobility to a cell supporting multiple TRPs as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing the propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred as a transmit (TX) beam. A wireless communication system operating at high frequency uses a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of receive (RX) beam patterns of different directions. Each of these receive patterns can be also referred as a receive (RX) beam.

The next generation wireless communication system (e.g., 5G, beyond 5G, 6G) supports a standalone mode of operation as well dual connectivity (DC). In DC a multiple Rx/Tx UE may be configured to utilize resources provided by two different nodes (or NBs) connected via a non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in the RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in the RRC_CONNECTED state not configured with CA/DC there is only one serving cell comprising the primary cell. For a UE in the RRC_CONNECTED state configured with CA/DC the term ‘serving cells’ is used to denote the set of cells comprising the Special Cell(s) (SpCells) and all secondary cells (SCells). In NR the term Master Cell Group (MCG) refers to a group of serving cells associated with the Master Node, comprising the Primary Cell (PCell) and optionally one or more SCells. In NR the term Secondary Cell Group (SCG) refers to a group of serving cells associated with the Secondary Node, comprising of the PSCell and optionally one or more SCells. In NR, PCell refers to a serving cell in an MCG, operating on the primary frequency, in which the UE either performs the initial connection establishment procedure or initiates the connection re-establishment procedure. In NR for a UE configured with CA, an SCell is a cell providing additional radio resources on top of a Special Cell. Primary SCG Cell (PSCell) refers to a serving cell in a SCG in which the UE performs random access when performing the Reconfiguration with Sync procedure. For Dual Connectivity operation the term SpCell refers to the PCell of the MCG or the PSCell of the SCG, otherwise the term Special Cell refers to the PCell.

In the next generation wireless communication system (e.g., 5G, beyond 5G, 6G), a node B (gNB) or base station in cell broadcast Synchronization Signal and PBCH block (SSB) includes primary and secondary synchronization signals (PSS, SSS) and system information. The system information includes common parameters needed to communicate in a cell. In the fifth generation wireless communication system (also referred as next generation radio or NR), system Information (SI) is divided into the master information block (MIB) and a number of system information blocks (SIBs) where: The MIB is transmitted on the BCH with a periodicity of 80 ms and repetitions made within 80 ms and the MIB includes parameters that are needed to acquire a SIB1 from the cell. The SIB1 is transmitted on the DL-SCH with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. The SIB1 includes information regarding the availability and scheduling (e.g., mapping of SIBs to an SI message, periodicity, SI-window size) of other SIBs with an indication whether one or more SIBs are only provided on-demand, and, in that case, the configuration needed by the UE to perform the SI request. SIB1 is a cell-specific SIB; SIBs other than SIB1 and posSIBs are carried in SystemInformation (SI) messages, which are transmitted on the DL-SCH. SIBs or posSIBs having the same periodicity can be mapped to the same SI message. SIBs and posSIBs are mapped to the different SI messages. Each SI message is transmitted within periodically occurring time domain windows (referred to as SI-windows with a same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. A cell specific SIB is applicable only within the cell that provides the SIB while an area specific SIB is applicable within an area referred to as an SI area, which includes one or several cells and is identified by systemInformationAreaID; The mapping of SIBs to SI messages is configured in schedulingInfoList, while the mapping of posSIBs to SI messages is configured in pos-SchedulingInfoList. Each SIB is contained in a single SI message and each SIB and posSIB is contained at most once in that SI message. For a the UE in RRC_CONNECTED state, the network can provide system information through dedicated signaling using the RRCReconfiguration message, e.g., if the UE has an active BWP with no common search space configured to monitor system information, paging, or upon request from the UE. In the RRC_CONNECTED state, the UE acquires the required SIB(s) from a PCell. For PSCells and SCells, the network provides the required SI by dedicated signaling, i.e., within an RRC Reconfiguration message. Nevertheless, the UE shall acquire the MIB of the PSCell to get SFN timing of the SCG (which may be different from MCG). Upon the change of relevant SI for the SCell, the network releases and adds the concerned SCell. For a PSCell, the required SI can be changed with Reconfiguration with Sync.

In the next generation wireless communication system (e.g., 5G, beyond 5G, 6G), a Physical Downlink Control Channel (PDCCH) is used to schedule DL transmissions on a physical downlink shared channel (PDSCH) and UL transmissions on physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of a configured PUSCH transmission with configured grant; activation and deactivation of a PDSCH semi-persistent transmission; notifying one or more UEs of the slot format; notifying one or more UEs of the PRB(s) and OFDM symbol(s) where the UE may assume no transmission is intended for the UE; transmission of TPC commands for PUCCH and PUSCH; transmission of one or more TPC commands for SRS transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET includes a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCE. Different code rates for the control channels are realized by aggregating a different number of CCEs. Interleaved and non-interleaved CCE-to-REG mapping is supported in a CORESET. Polar coding is used for the PDCCH. Each resource element group carrying the PDCCH carries its own DMRS. QPSK modulation is used for the PDCCH.

In the next generation wireless communication system (e.g., 5G, beyond 5G, 6G), a list of search space configurations is signaled by the GNB for each configured BWP of the serving cell wherein each search configuration is uniquely identified by a search space identifier. The search space identifier is unique amongst the BWPs of a serving cell. An identifier of a search space configuration to be used for a specific purpose such as paging reception, SI reception, random access response reception, etc. is explicitly signaled by the gNB for each configured BWP. In NR a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration where the slot with number ‘x’ in a radio frame with number ‘y’ satisfies the equation below: (y*(number of slots in a radio frame)+x−Monitoring-offset-PDCCH-slot) mod (Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations are signaled by the gNB for each configured BWP of the serving cell, wherein each CORESET configuration is uniquely identified by a CORESET identifier. The Coreset identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing. The number of slots in a radio frame and duration of slots for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in the TCI state list is activated and indicated to the UE by the gNB. The TCI state indicates the DL TX beam (DL TX beam is QCLed with SSB/CSI RS of TCI state) used by the gNB for transmission of a PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE only has to monitor the PDCCH on the one active BWP i.e., it does not have to monitor the PDCCH on the entire DL frequency of the serving cell. In the RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a time. The BWP switching is controlled by the PDCCH indicating a downlink assignment or an uplink grant, by the bwp-Inactivity Timer, by RRC signaling, or by the MAC entity itself upon initiation of a Random-Access procedure. Upon addition of an SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of a BWP inactivity timer the UE switches from the active DL BWP to the default DL BWP or initial DL BWP (if a default DL BWP is not configured).

In the next generation wireless communication system (e.g., 5G, beyond 5G, 6G), random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UEs in the RRC CONNECTED state. Several types of random access procedures are supported.

In contention based random access (CBRA), also referred to as 4 step CBRA, the UE first transmits a random access preamble (also referred to as a Msg1) and then waits for a random access response (RAR) in the RAR window. A RAR is also referred to as a Msg2. A next generation node B (gNB) transmits the RAR on the PDSCH. A PDCCH scheduling the PDSCH carrying the RAR is addressed to an RA-radio network temporary identifier (RA-RNTI). RA-RNTI identifies the time-frequency resource (also referred as physical RA channel (PRACH) occasion or PRACH transmission (TX) occasion or RA channel [RACH] occasion) in which an RA preamble was detected by the gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted a Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier. Several RARs for various Random-access preambles detected by the gNB can be multiplexed in the same RAR media access control (MAC) protocol data unit (PDU) by the gNB. A RAR in a MAC PDU corresponds to the UE's RA preamble transmission if the RAR includes an RA preamble identifier (RAPID) of an RA preamble transmitted by the UE. If the RAR corresponding to the UE's RA preamble transmission is not received during the RAR window and the UE has not yet transmitted the RA preamble for a configurable (configured by the gNB in a RACH configuration) number of times, the UE goes back to the first step i.e., selecting a random access resource (preamble/RACH occasion) and transmits the RA preamble. A backoff may be applied before going back to the first step.

If the RAR corresponding to the UE's RA preamble transmission is received the UE transmits a message 3 (Msg3) in the UL grant received in the RAR. The Msg3 includes a message such as an RRC connection request, RRC connection re-establishment request, RRC handover confirm, scheduling request, SI request etc. The Msg3 may include the UE identity (i.e., cell-radio network temporary identifier (C-RNTI) or system architecture evolution (SAE)-temporary mobile subscriber identity (S-TMSI) or a random number). After transmitting the Msg3, the UE starts a contention resolution timer. While the contention resolution timer is running, if the UE receives a physical downlink control channel (PDCCH) addressed to the C-RNTI included in the Msg3, contention resolution is considered successful, the contention resolution timer is stopped, and the RA procedure is completed. While the contention resolution timer is running, if the UE receives a contention resolution MAC control element (CE) including the UE's contention resolution identity (the first X bits of the common control channel [CCCH] service data unit [SDU] transmitted in the Msg3), contention resolution is considered successful, the contention resolution timer is stopped, and the RA procedure is completed. If the contention resolution timer expires and the UE has not yet transmitted the RA preamble for a configurable number of times, the UE goes back to the first step i.e., selecting a random access resource (preamble/RACH occasion) and transmits the RA preamble. A backoff may be applied before going back to the first step.

Contention free random access (CFRA), also referred to as legacy CFRA or 4 step CFRA, is used for scenarios such as handover where low latency is required, timing advance establishment for a secondary cell (Scell), etc. An Evolved node B (eNB) assigns to the UE a dedicated Random access preamble. The UE transmits the dedicated RA preamble. The eNB transmits the RAR on the PDSCH addressed to an RA-RNTI. The RAR conveys an RA preamble identifier and timing alignment information. The RAR may also include an UL grant. The RAR is transmitted in a RAR window similar to contention-based RA (CBRA) procedure. The CFRA is considered successfully completed after receiving the RAR including the RA preamble identifier (RAPID) of the RA preamble transmitted by the UE. In case RA is initiated for beam failure recovery, the CFRA is considered successfully completed if a PDCCH addressed to the C-RNTI is received in the search space for beam failure recovery. If the RAR window expires and the RA is not successfully completed and UE has not yet transmitted the RA preamble for a configurable (configured by the gNB in a RACH configuration) number of times, the UE retransmits the RA preamble.

For certain events such has handover and beam failure recovery if dedicated preamble(s) are assigned to the UE, during the first step of random access i.e., during random access resource selection for the Msg1 transmission the UE determines whether to transmit a dedicated preamble or non-dedicated preamble. Dedicated preambles are typically provided for a subset of SSBs/CSI RSs. If there is no SSB/CSI RS having a DL RSRP above a threshold amongst the SSBs/CSI RSs for which contention free random access resources (i.e., dedicated preambles/ROs) are provided by the gNB, the UE selects a non-dedicated preamble. Otherwise, the UE selects a dedicated preamble. Therefore, during the RA procedure, one random access attempt can be a CFRA while other random access attempt can be a CBRA.

For 2 step contention based random access (2 step CBRA), in the first step, the UE transmits a random access preamble on a PRACH and a payload (i.e., MAC PDU) on a PUSCH. The random access preamble and payload transmission is also referred to as a MsgA. In the second step, after MsgA transmission, the UE monitors for a response from the network (i.e., gNB) within a configured window. The response is also referred to as a MsgB. A next generation node B (gNB) transmits the MsgB on a PDSCH. A PDCCH scheduling the PDSCH carrying the MsgB is addressed to a MsgB-radio network temporary identifier (MSGB-RNTI). The MSGB-RNTI identifies the time-frequency resource (also referred as to as a physical RA channel [PRACH] occasion or PRACH transmission [TX] occasion or RA channel [RACH] occasion) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where the UE has transmitted the Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If a common control channel (CCCH) service data unit (SDU) was transmitted in the MsgA payload, the UE performs contention resolution using the contention resolution information in the MsgB. The contention resolution is successful if the contention resolution identity received in the MsgB matches first 48 bits of the CCCH SDU transmitted in the MsgA. If a C-RNTI was transmitted in the MsgA payload, the contention resolution is successful if the UE receives PDCCH addressed to the C-RNTI. If contention resolution is successful, the random access procedure is considered successfully completed. Instead of contention resolution information corresponding to the transmitted MsgA, The MsgB may include fallback information corresponding to the random access preamble transmitted in the MsgA. If the fallback information is received, the UE transmits a Msg3 and performs contention resolution using a Msg4 as in CBRA procedure. If the contention resolution is successful, random access procedure is considered successfully completed. If contention resolution fails upon fallback (i.e., upon transmitting Msg3), the UE retransmits the MsgA. If the configured window in which the UE monitors the network response after transmitting the MsgA expires and the UE has not received a MsgB including contention resolution information or fallback information as explained above, the UE retransmits the MsgA. If the random access procedure is not successfully completed even after transmitting the MsgA a configurable number of times, the UE falls back to the 4 step RACH procedure i.e., the UE only transmits the PRACH preamble.

The MsgA payload may include one or more of a common control channel (CCCH) service data unit (SDU), dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. The MsgA may include a UE ID (e.g., random ID, S-TMSI, C-RNTI, resume ID, etc.) along with the preamble in the first step. The UE ID may be included in the MAC PDU of the MsgA. A UE ID such as a C-RNTI may be carried in the MAC CE wherein the MAC CE is included in the MAC PDU. Other UE IDs (such as a random ID, S-TMSI, C-RNTI, resume ID, etc.) may be carried in a CCCH SDU. The UE ID can be one of a random ID, S-TMSI, C-RNTI, resume ID, IMSI, idle mode ID, inactive mode ID, etc. The UE ID can be different in different scenarios in which the UE performs the RA procedure. When the UE performs RA after power on (before the UE is attached to the network), then the UE ID is a random ID. When the UE performs RA in an IDLE state after the UE is attached to the network, the UE ID is an S-TMSI. If the UE has an assigned C-RNTI (e.g., in the connected state), the UE ID is a C-RNTI. In case the UE is in the INACTIVE state, the UE ID is a resume ID. In addition to the UE ID, some addition ctrl information can be sent in the MsgA. The control information may be included in the MAC PDU of the MsgA. The control information may include one or more of a connection request indication, connection resume request indication, SI request indication, buffer status indication, beam information (e.g., one or more DL TX beam ID(s) or SSB ID(s)), beam failure recovery indication/information, data indicator, cell/BS/TRP switching indication, connection re-establishment indication, reconfiguration complete or handover complete message, etc.

In 2 step contention free random access (2 step CFRA), the gNB assigns to the UE a dedicated random access preamble(s) and PUSCH resource(s) for MsgA transmission. RO(s) to be used for preamble transmission may also be indicated. In the first step, the UE transmits a random access preamble on the PRACH and a payload on the PUSCH using the contention free random access resources (i.e., dedicated preamble/PUSCH resource/RO). In the second step, after the MsgA transmission, the UE monitors for a response from the network (i.e., gNB) within a configured window. The response is also referred to as a MsgB.

A Next generation node B (gNB) transmits the MsgB on a physical downlink shared channel (PDSCH). A PDCCH scheduling the PDSCH carrying the MsgB is addressed to a MsgB-radio network temporary identifier (MSGB-RNTI). The MSGB-RNTI identifies the time-frequency resource (also referred to as a physical RA channel [PRACH] occasion or PRACH transmission [TX] occasion or RA channel [RACH] occasion) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where the UE has transmitted the Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If the UE receives a PDCCH addressed to the C-RNTI, the random access procedure is considered successfully completed. If the UE receives fallback information corresponding to its transmitted preamble, the random access procedure is considered successfully completed.

For certain events, such has handover and beam failure recovery, if dedicated preamble(s) and PUSCH resource(s) are assigned to the UE, during the first step of random access i.e., during random access resource selection for MsgA transmission, the UE determines whether to transmit a dedicated preamble or non-dedicated preamble. Dedicated preambles are typically provided for a subset of SSBs/CSI RSs. If there is no SSB/CSI RS having a DL RSRP above a threshold amongst the SSBs/CSI RSs for which contention free random access resources (i.e., dedicated preambles/ROs/PUSCH resources) are provided by the gNB, the UE selects a non-dedicated preamble. Otherwise, the UE selects a dedicated preamble. Therefore, during the RA procedure, one random access attempt can be 2 step CFRA while other random access attempt can be 2 step CBRA.

Upon initiation of a random access procedure, the UE first selects the carrier (SUL or NUL). If the carrier to use for the random-access procedure is explicitly signaled by the gNB, the UE selects the signaled carrier for performing the random-access procedure. If the carrier to use for the random-access procedure is not explicitly signaled by the NB, and if the Serving Cell for the random-access procedure is configured with a supplementary uplink, and if the RSRP of the downlink pathloss reference is less than rsrp-ThresholdSSB-SUL, the UE selects the SUL carrier for performing random access procedure. Otherwise, the UE selects the NUL carrier for performing the random-access procedure. Upon selecting the UL carrier, the UE determines the UL and DL BWP for the random access procedure. The UE then determines whether to perform a 2 step or 4 step RACH for this random access procedure.

If this random access procedure is initiated by a PDCCH order and if the ra-PreambleIndex explicitly provided by PDCCH is not 0b000000, the UE selects 4 step RACH. Otherwise, if 2 step contention free random access resources are signaled by the gNB for this random access procedure, the UE selects 2 step RACH. Otherwise, if 4 step contention free random access resources are signaled by the gNB for this random access procedure, the UE selects 4 step RACH. Otherwise, if the UL BWP selected for this random access procedure is configured with only 2 step RACH resources, the UE selects 2 step RACH. Otherwise, if the UL BWP selected for this random access procedure is configured with only 4 step RACH resources, the UE selects 4 step RACH. Otherwise, if the UL BWP selected for this random access procedure is configured with both 2 step and 4 step RACH resources, if the RSRP of the downlink pathloss reference is below a configured threshold, the UE selects 4 step RACH. Otherwise, the UE selects 2 step RACH.

Layer 1 (L1)/Layer 2 (L2) Triggered Mobility (LTM), also referred to herein as lower layer triggered mobility, is a procedure in which a gNB receives L1/L3 measurement report(s) from a UE, and on the basis of the L1/L3 measurement report(s) the gNB changes the UE's serving cell by a cell switch command signaled via a MAC CE. The cell switch command indicates an LTM candidate cell configuration that the gNB previously prepared and provided to the UE through RRC signaling. Then the UE switches to the target cell according to the cell switch command. The LTM procedure can be used to reduce mobility latency. The network may request the UE to perform early TA acquisition of a candidate cell before a cell switch. The early TA acquisition is triggered by a PDCCH order or through a UE-based TA measurement.

The network indicates in the cell switch command whether the UE shall access the target cell with a RA procedure if a TA value is not provided or with PUSCH transmission using the indicated TA value. For RACH-less LTM, the UE accesses the target cell via the configured grant provided in the RRC signaling and selects the configured grant occasion associated with the beam indicated in the cell switch command. If the UE does not receive the configured grant in the RRC signaling, the UE monitors the PDCCH for dynamic scheduling from the target cell upon the LTM cell switch. Before RACH-less LTM procedure completion, the UE shall not trigger a random access procedure if it does not have a valid PUCCH resource for triggered SRs.

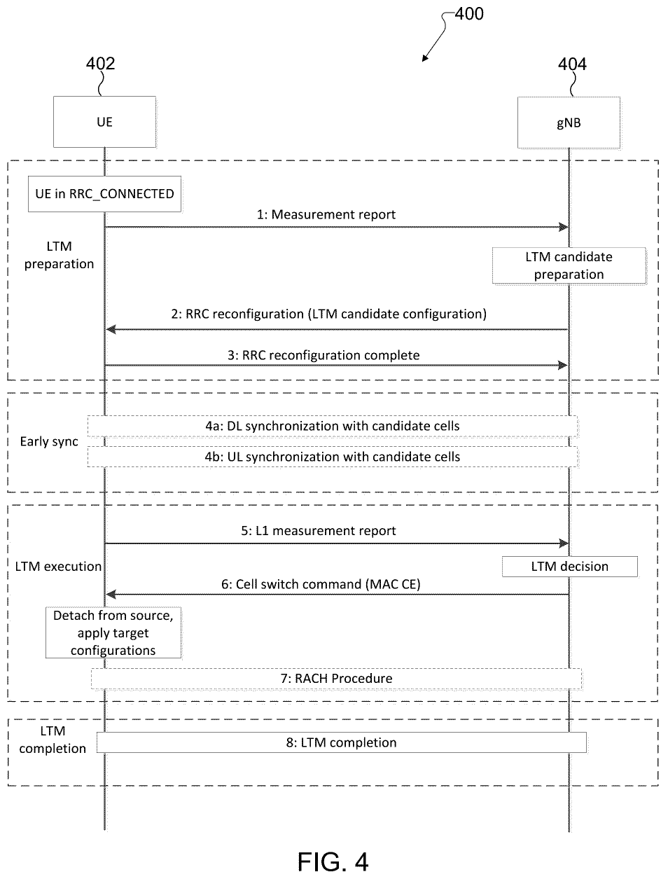

FIG. 4 illustrates an example procedure for lower layer triggered mobility 400 according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of lower layer triggered mobility could be used without departing from the scope of this disclosure.

In the Example of FIG. 4, a UE 402 is in an RRC_CONNECTED state. A step 1, UE 402 sends a MeasurementReport message to a gNB 404. gNB 404 decides to configure LTM and initiates candidate cell(s) preparation.

At step 2, gNB 404 transmits an RRCReconfiguration message to UE 402 including the LTM candidate cell configurations of one or multiple candidate cells.

At step 3, UE 402 stores the LTM candidate cell configurations and transmits an RRCReconfigurationComplete message to gNB 404

At step 4a, UE 402 may perform DL synchronization with candidate cell(s) before receiving the cell switch command.

At step 4b, if requested by the network, UE 402 performs early TA acquisition with candidate cell(s) before receiving the cell switch command. The early TA acquisition is performed via a CFRA triggered by a PDCCH order from the source cell, following which UE 402 sends a preamble towards the indicated candidate cell. In order to minimize the data interruption of the source cell due to the CFRA towards the candidate cell(s), UE 402 does not receive a RAR for the purpose of TA value acquisition and the TA value of the candidate cell is indicated in the cell switch command. The UE doesn't maintain the TA timer for the candidate cell and relies on network implementation to guarantee the TA validity.

At step 5, UE 402 performs L1/L3 measurements on the configured candidate cell(s) and transmits L1/L3 measurement reports to gNB 404.

At step 6, gNB 404 decides to execute a cell switch to a target cell and transmits a MAC CE triggering the cell switch by including the candidate configuration index of the target cell. UE 402 switches to the target cell and applies the configuration indicated by the candidate configuration index.

At step 7, UE 402 performs a random access procedure towards the target cell, if UE 402 does not have valid TA of the target cell.

At step 8, UE 402 completes the LTM cell switch procedure by sending an RRCReconfigurationComplete message to the target cell. If UE 402 has performed an RA procedure in step 7, UE 402 considers that LTM execution is successfully completed when the random access procedure is successfully completed. For RACH-less LTM, UE 402 considers that LTM execution is successfully completed when UE 402 determines that the network has successfully received its first UL data. UE 402 determines successful reception of its first UL data by receiving a PDCCH addressing UE 402's C-RNTI in the target cell, which schedules a new transmission following the first UL data.

Although FIG. 4 illustrates one example procedure for lower layer triggered mobility 400, various changes may be made to FIG. 4. For example, while shown as a series of steps, various steps in FIG. 4 could overlap, occur in parallel, occur in a different order, occur any number of times, be omitted, or replaced by other steps.

In existing wireless communication systems, a cell is associated with one Timing Advance Group, wherein the UE maintains one Timing Advance (or TA) value per TAG which is used for adjusting UL timing for the cell(s) associated with that TAG. Recently multiple Transmit Receive Point (TRP) communication is being enabled in 5G systems, wherein a cell can have multiple TRPs, and the UE can communicate with each of the TRPs of the cell to enhance throughput and reliability. DCI can be transmitted independently from each of these TRPs, and UL can be transmitted to each of these TRPs independently using the corresponding UL timing. In order to do this the UE needs to maintain multiple TAs per cell unlike the existing system wherein only one TA is maintained per cell. Each of the TRPs of the cell can be associated with the same physical cell identifier (PCI) or a different PCI.

If a target cell is associated with multiple TRPs, the target cell can be associated with multiple TAGs. In the case of LTM, the UE may estimate the TA itself or it may receive the TA in an LTM cell switch command. In case multiple TAGs are supported in the target cell, the UE does not know to which TAG the UE estimated TA or TA received in the LTM cell switch command should be applied. The present disclosure provides procedures that enable the UE to determine which TAG to apply the UE estimated TA or TA received in the LTM cell switch command.

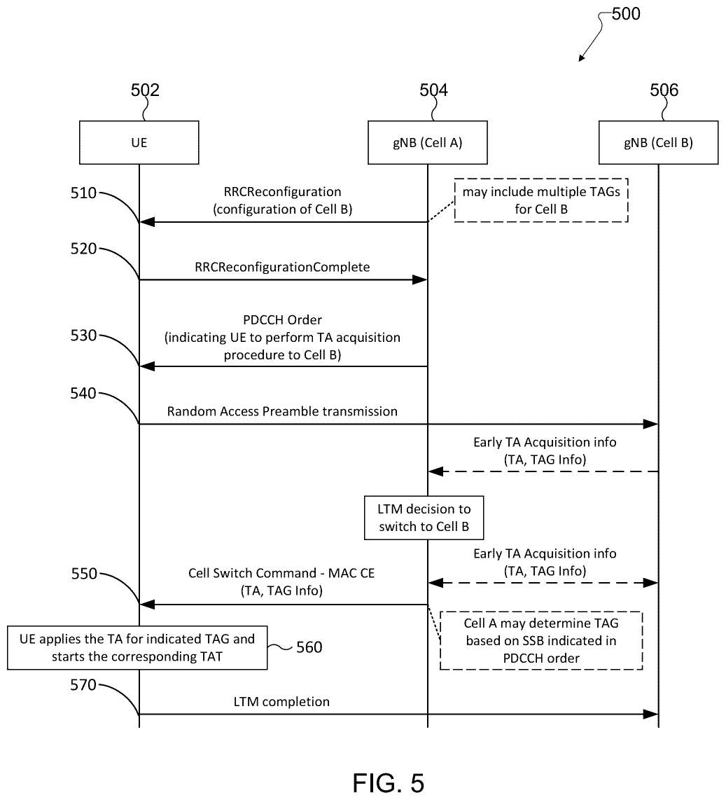

FIG. 5 illustrates an example procedure for lower layer triggered mobility to a cell supporting multiple TRPs/TAGs 500 according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of lower layer triggered mobility to a cell supporting multiple TRPs/TAGs could be used without departing from the scope of this disclosure.

In the example of FIG. 5, the process begins at step 510. At step 510 gNB (or base station) 504 of Cell A provides the LTM configuration of candidate Cell B to UE 502. Cell A is a serving cell. Cell B is associated with multiple TRPs/TAGs. A TAG ID of each of the TAGs is included in the LTM configuration of candidate Cell B. In one embodiment, the number of multiple TRPs/TAGs can be 2 and one of these TAGS/TAG IDs can be referred to as a first TAG (identified by a TAG index 0) and another can be referred as second TAG (identified by a TAG index 1). The LTM configuration of candidate Cell B may include a TA acquisition configuration. The TA acquisition configuration includes RRC configuration information used to send a random access preamble to Cell B so that gNB 506 to which Cell B belongs can calculate a TA value to be used by UE 502, e.g., in case an LTM cell switch procedure is executed to Cell B. The LTM configuration of candidate Cell B may include a configuration of Cell B to be applied in case an LTM cell switch procedure is executed to Cell B. The LTM configuration of candidate Cell B may include a list of TCI states wherein each TCI state is associated to one of the TAGs of Cell B. In case Cell A and Cell B belong to different DUs of the same gNB, the gNB (or base station) 504 may obtain the configuration of Cell B from the distributed unit (DU) of Cell B. In case Cell A and Cell B belong to a different DU of different gNB, gNB (or base station or centralized unit [CU]) 504 of Cell A may obtain the configuration of Cell B from gNB (or base station or CU) 506 of Cell B. The LTM configuration of candidate Cell B may include an L1 measurement configuration.

At step 520, UE 502 confirms the RRC Reconfiguration by transmitting an RRCReconfiguration complete message.

At step 530, gNB (or base station) 504 to which Cell A belongs sends a PDCCH order to UE 502 in order to initiate a TA acquisition procedure with Cell B. The PDCCH order includes the information (e.g., random access preamble index, SSB index, UL carrier [SUL or NUL]) used to send a random access preamble to Cell B. Note that after transmitting the RRCReconfiguration complete message, UE 502 performs L1 measurements of Cell B and reports the measurements to gNB (or base station) 504 to which Cell A belongs. Based on these measurements gNB 504 can identify an UL carrier and SSB index of Cell B to be included in the PDCCH order.

At step 540, UE 502 sends a random access preamble to Cell B so that gNB 506 to which Cell B belongs can calculate a TA value to be used by UE 502, e.g., if an LTM cell switch procedure is triggered to Cell B.

In one embodiment, in case Cell A and Cell B belong to different DUs of the same gNB, the DU of Cell B can determine the TA and TAG based on the received random access preamble and inform the DU of Cell A about the determined TA and TAG. A TAG ID or TAG index of the determined TAG is informed by the DU of Cell B to the DU of Cell A. For example, Cell B may be associated two TAGs with TAG IDs, TAG A and TAG B. TAG A can be referred to by a logical TAG index 0 and TAG B can be referred to by logical TAG index 1. In one embodiment, the DU of Cell B informs the DU of Cell A about the TA and TAG upon receiving the random access preamble. In an alternate embodiment, the DU of Cell B informs the DU of Cell A about TA and TAG upon receiving the request for such information from the DU of Cell A, wherein the DU of Cell A may request when the DU of Cell A determines to switch to Cell B. The DU of Cell B can determine the TAG based on the SSB associated with the received random access preamble. Different TRPs/TAGs of Cell B can be associated with different SSBs, so based on the SSB associated with the received random access preamble, the DU of Cell B can determine the TRP/TAG.

In one embodiment, in case Cell A and Cell B belongs to the same DU of the same gNB, the DU determines the TA and TAG based on the received random access preamble and inform the DU of Cell A about the determined TA and TAG. For example, Cell B may be associated two TAGs with TAG IDs, TAG A and TAG B. TAG A can be referred to by a logical TAG index 0 and TAG B can be referred to by a logical TAG index 1. The DU of Cell B can determine the TAG based on the SSB associated with the received random access preamble. Different TRPs/TAGs of Cell B can be associated with different SSBs, so based on the SSB associated with the received random access preamble, the DU of Cell B can determine the TRP/TAG.

In one embodiment, in case Cell A and Cell B belong to a different DU of a different gNB, the DU of Cell B can determine the TA and TAG based on the received random access preamble and inform the CU of Cell B about the determined TA and TAG. The CU of Cell B then sends this information to the CU of Cell A and the CU of Cell A informs this information to the DU of Cell A. A TAG ID or TAG index of the determined TAG is informed by the DU of Cell B to the DU of Cell A. In one embodiment, the DU of Cell B can determine the TA and TAG based on the received random access preamble and inform the DU of Cell A about the determined TA and TAG of Cell B. For example, Cell B may be associated two TAGs with TAG IDs, TAG A and TAG B. TAG A can be referred to by a logical TAG index 0 and TAG B can be referred to by a logical TAG index 1. The DU of Cell B can determine the TAG based on the SSB associated with the received random access preamble. Different TRPs/TAGs of Cell B can be associated with different SSBs, so based on the SSB associated with the received random access preamble, the DU of Cell B can determine the TRP/TAG.

In one embodiment, in case Cell A and Cell B belong to a different DU of a different gNB, the DU of Cell B can determine the TA and TAG based on the received random access preamble and inform the UE directly by sending a RAR including the above information. A TAG ID or TAG index of the determined TAG is included in a RAR. The DU of Cell B can determine the TAG based on the SSB associated with the received random access preamble. Different TRPs/TAGs of Cell B can be associated with different SSBs, so based on the SSB associated with the received random access preamble, the DU of Cell B can determine the TRP/TAG.

At step 550, gNB (or base station) 504 of Cell A decides to execute cell switch to a target cell B and transmits a MAC CE triggering the cell switch by including the candidate configuration index of the target cell i.e., Cell B, TA of Cell B, TAG ID or TAG index associated with the TA received from gNB 506 of Cell B. In one embodiment, multiple TAs of Cell B can be included in the MAC CE triggering the cell switch. The TAG associated with each of these TAs of Cell B is included in the MAC CE triggering the cell switch. The TAG associated with each of these TAs of Cell B is not included in the MAC CE triggering the cell switch and the first TA included in the MAC CE belongs to first TAG and the second TA included in the MAC CE belongs to the second TAG. In an embodiment, number of multiple TRPs/TAGs can be 2. Multiple TA/TAGs can be determined using the operations in step 530 and step 540. In one embodiment, one or more TCI state identifiers (identifying a joint/UL TCI state/DL TCI state) for each of multiple TRPs of Cell B can be included in the MAC CE triggering cell switch.

At step 560, UE 502 switches to the target cell B and applies the configuration indicated by the candidate configuration index (At step 510 UE 502 may receive an LTM configuration of multiple candidate cells and each configuration is identified by a candidate configuration index). UE 502 applies the TA received in the MAC CE triggering cell switch for the TAG (identified by a TAG ID or TAG index) indicated in the MAC CE triggering the cell switch and starts the corresponding TAT. For example, Cell B may be associated two TAGs with TAG IDs, TAG A and TAG B. TAG A can be referred to by a logical TAG index 0 and TAG B can be referred to by a logical TAG index 1. MAC CE may include TAG ID i.e., TAG A or TAG B. MAC CE may include TAG index and UE can identify TAG A or TAG B based on TAG ID to TAG index mapping.

At step 570, UE 502 completes the LTM cell switch procedure by sending an RRCReconfigurationComplete message to target cell B. In one embodiment, if target cell B is not associated with multiple TAGs and a valid TA for the target cell B is available (e.g., received in the MAC CE triggering cell switch or UE 502 has estimated the TA) to UE 502, UE 502 does not initiate a RACH, performs a RACH-less LTM cell switch, and transmits the first UL PUSCH transmission using a configured UL grant or dynamic UL grant. The first UL transmission includes the RRCReconfigurationComplete message. In one embodiment, if one uplink TCI state identifier is included in the MAC CE triggering the cell switch and target cell B is associated with multiple TAGs and a valid TA for the TAG associated with the TCI state (identified by the uplink TCI state identifier) is available (e.g., received in the MAC CE triggering the cell switch or UE 502 has estimated the TA) to UE 502, UE 502 does not initiate a RACH, performs a RACH-less LTM cell switch, and transmits the first UL PUSCH transmission using a configured UL grant or dynamic UL grant. The first UL transmission includes the RRCReconfigurationComplete message. In one embodiment, if two uplink TCI state identifiers are included in the MAC CE triggering the cell switch and target cell B is associated with multiple TAGs and a valid TA for the TAG associated with the TCI state identified by the at least one uplink TCI state identifier is available (e.g., received in the MAC CE triggering the cell switch or UE 502 has estimated the TA) to UE 502, UE does 502 not initiate a RACH, performs a RACH-less LTM cell switch, and transmits the first UL PUSCH transmission using a configured UL grant or dynamic UL grant. The first UL transmission includes the RRCReconfigurationComplete message.

Although FIG. 5 illustrates one example procedure for lower layer triggered mobility to a cell supporting multiple TRPs/TAGs 500, various changes may be made to FIG. 5. For example, while shown as a series of steps, various steps in FIG. 5 could overlap, occur in parallel, occur in a different order, occur any number of times, be omitted, or replaced by other steps.

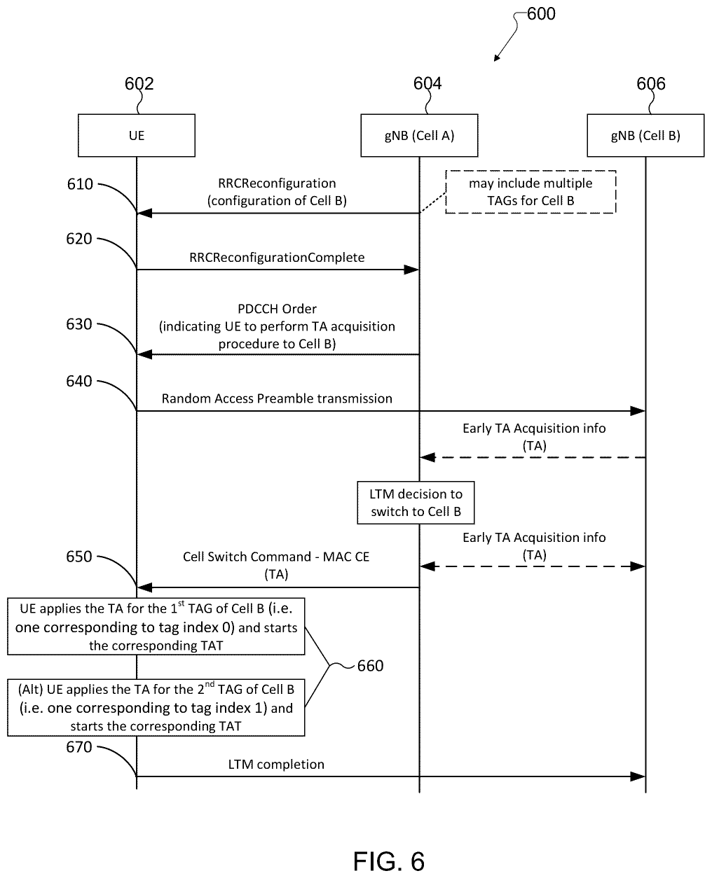

FIG. 6 illustrates another example procedure for lower layer triggered mobility to a cell supporting multiple TRPs/TAGs 600 according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of lower layer triggered mobility to a cell supporting multiple TRPs/TAGs could be used without departing from the scope of this disclosure.

In the example of FIG. 6, the process begins at step 610. At step 610 gNB (or base station) 604 of Cell A provides the LTM configuration of candidate Cell B to UE 602. Cell A is a serving cell. Cell B is associated with multiple TRPs/TAGs. In one embodiment, the number of multiple TRPs/TAGs can be 2. A TAG ID of each of the TAGs is included in the LTM configuration of candidate Cell B. The LTM configuration of candidate Cell B may include a TA acquisition configuration. The TA acquisition configuration includes RRC configuration information used to send a random access preamble to Cell B so that gNB 606 to which Cell B belongs can calculate a TA value to be used by UE 602, e.g., in case an LTM cell switch procedure is executed to Cell B. The LTM configuration of candidate Cell B may include a configuration of Cell B to be applied in case an LTM cell switch procedure is executed to Cell B. The LTM configuration of candidate Cell B may include a list of TCI states wherein each TCI state is associated to one of the TAGs of Cell B. In case Cell A and Cell B belong to a different DU of the same gNB, gNB (or base station) 604 may obtain the configuration of Cell B from the DU of Cell B. In case Cell A and Cell B belong to a different DU of a different gNB, gNB (or base station or CU) 604 of Cell A may obtain the configuration of Cell B from gNB (or base station or CU) 606 of Cell B. The LTM configuration of candidate Cell B may include an L1 measurement configuration.

At step 620, UE 620 confirms the RRC Reconfiguration by transmitting an RRCReconfiguration complete message.

At step 630 gNB (or base station) 604 to which Cell A belongs sends a PDCCH order to UE 602 in order to initiate a TA acquisition procedure with Cell B. The PDCCH order includes the information (e.g., random access preamble index, SSB index, UL carrier [SUL or NUL]) used to send a random access preamble to Cell B. Note that after transmitting the RRCReconfiguration complete message, UE 602 performs L1 measurements of Cell B and reports these to gNB (or base station) 604 to which Cell A belongs. Based on these measurements gNB 604 can identify an UL carrier and SSB index of Cell B to be included in the PDCCH order.

At step 640, UE 602 sends a random access preamble to Cell B so that gNB 606 to which Cell B belongs can calculate a TA value to be used by UE 602, e.g., if an LTM cell switch procedure is triggered to Cell B.

In one embodiment, in case Cell A and Cell B belong to a different DU of same gNB, the DU of Cell B can determine the TA based on the received random access preamble and inform the DU of Cell A about the determined TA. In one embodiment, the DU of Cell B informs the DU of Cell A about the TA upon receiving the random access preamble. In an another embodiment, the DU of Cell B informs the DU of Cell A about the TA upon receiving the request for such information from the DU of Cell A, wherein the DU of Cell A may request the information when the DU of Cell A determines to switch to Cell B.

In one embodiment, in case Cell A and Cell B belong to the same DU of the same gNB, the DU determines the TA based on the received random access preamble and informs the DU of Cell A about the determined TA.

In one embodiment, in case Cell A and Cell B belong to a different DU of a different gNB, the DU of Cell B can determine the TA based on the received random access preamble and inform the CU of Cell B about the determined TA. The CU of Cell B then sends this information to the CU of Cell A and the CU of Cell A informs this information to the DU of Cell A. In one embodiment, the DU of Cell B can determine the TA based on the received random access preamble and inform the DU of Cell A about the determined TA.

At step 650, gNB (or base station) 604 of cell A decides to execute a cell switch to a target cell and transmits a MAC CE triggering the cell switch by including the candidate configuration index of the target cell i.e., Cell B, TA of Cell B. In one embodiment, TCI state identifiers (identifying joint/UL TCI state/DL TCI state) for each of multiple TRPs of Cell B can be included in the MAC CE triggering cell switch.

At step 660, UE 602 switches to the target cell B and applies the configuration indicated by the candidate configuration index (At step 610 the UE may receive an LTM configuration of multiple candidate cells, and each configuration is identified by a candidate configuration index). In one embodiment, UE 602 applies the TA received in the MAC CE triggering the cell switch for the 1^{st} TAG (e.g., one corresponding to tag index 0 or which of the two TAGs is first or second can be pre-defined) and starts the corresponding TAT. In another embodiment, UE 602 applies the TA received in the MAC CE triggering the cell switch for the 2^{nd} TAG (e.g., one corresponding to tag index 1 or which of the two TAGs is first or second can be pre-defined) and starts the corresponding TAT. In one embodiment, UE 602 can determine the TAG based on the SSB associated with the transmitted random access preamble (i.e., SSB index indicated in PDCCH order) in step 640. Different TRPs/TAGs of Cell B can be associated with different SSBs, so based on SSB associated with the transmitted random access preamble (i.e., SSB index indicated in PDCCH order), UE 602 can determine the TRP/TAG. Mapping between SSBs and TAGs of Cell B can be indicated to UE 602 in the configuration of Cell B. Alternately, mapping between TCI states and TAGs of Cell B can be indicated to UE 602 in the configuration of Cell B wherein an RS associated with a TCI state is SSB.

At step 670, UE 670 completes the LTM cell switch procedure by sending an RRCReconfigurationComplete message to target Cell B. In one embodiment, if target Cell B is not associated with multiple TAGs and a valid TA for the target Cell B is available (e.g., received in the MAC CE triggering the cell switch or UE 602 has estimated the TA) to UE 602, UE 602 does not initiate a RACH, performs RACH-less LTM cell switch, and transmits the first UL PUSCH transmission using a configured UL grant or dynamic UL grant. The first UL transmission includes the RRCReconfigurationComplete message. In one embodiment, if one uplink TCI state identifier is included in the MAC CE triggering the cell switch and target Cell B is associated with multiple TAGs and a valid TA for the TAG associated with the TCI state (identified by an uplink TCI state identifier) is available (e.g., received in the MAC CE triggering the cell switch or UE 602 has estimated the TA) to UE 602, UE 602 does not initiate a RACH, performs a RACH-less LTM cell switch, and transmits the first UL PUSCH transmission using a configured UL grant or dynamic UL grant. The first UL transmission includes the RRCReconfigurationComplete message. In another embodiment, if two uplink TCI state identifiers are included in the MAC CE triggering the cell switch and target Cell B is associated with multiple TAGs and a valid TA for the TAG associated with the TCI state identified by at least one uplink TCI state identifier is available (e.g., received in the MAC CE triggering the cell switch or UE 602 has estimated the TA) to UE 602, UE 602 does not initiate a RACH, performs a RACH-less LTM cell switch, and transmits the first UL PUSCH transmission using a configured UL grant or dynamic UL grant. The first UL transmission includes the RRCReconfigurationComplete message.

Although FIG. 6 illustrates one example procedure for lower layer triggered mobility to a cell supporting multiple TRPs/TAGs 600, various changes may be made to FIG. 6. For example, while shown as a series of steps, various steps in FIG. 6 could overlap, occur in parallel, occur in a different order, occur any number of times, be omitted, or replaced by other steps.

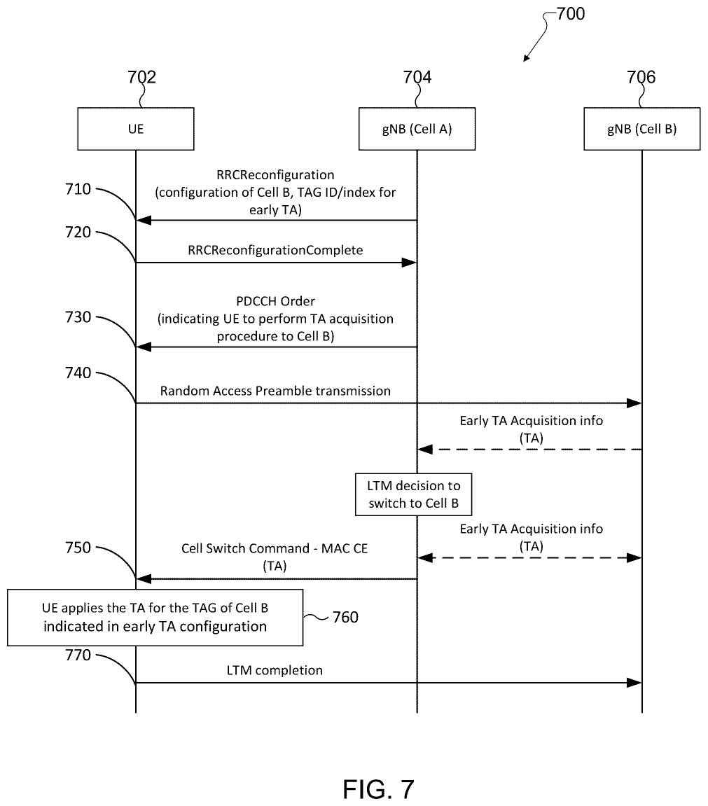

FIG. 7 illustrates another example procedure for lower layer triggered mobility to a cell supporting multiple TRPs/TAGs 700 according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of lower layer triggered mobility to a cell supporting multiple TRPs/TAGs could be used without departing from the scope of this disclosure.

In the example of FIG. 7, the process begins at step 710. At step 710 (gNB or base station) 704 of Cell A provides the LTM configuration of candidate Cell B to UE 702. Cell A is a serving cell. Cell B is associated with multiple TRPs/TAGs. In one embodiment, the number of multiple TRPs/TAGs can be 2. A TAG ID of each of the TAGs is included in the LTM configuration of candidate Cell B. One of these TAG/TAG IDs can be referred to as a first TAG (identified by TAG index 0) and another can be referred to as a second TAG (identified by TAG index 1). The LTM configuration of candidate Cell B may include a TA acquisition configuration. The TA acquisition configuration includes RRC configuration information used to send a random access preamble to Cell B so that gNB 706 to which Cell B belongs can calculate a TA value to be used by UE 702, e.g., in case an LTM cell switch procedure is executed to Cell B. The TAG ID/TAG index of the TAG associated with early TA is included in the TA acquisition configuration. The LTM configuration of candidate Cell B may include a configuration of Cell B to be applied in case an LTM cell switch procedure is executed to Cell B. The LTM configuration of candidate Cell B may include a list of TCI states wherein each TCI state is associated to one of the TAGs of Cell B. In case Cell A and Cell B belong to a different DU of the same gNB, gNB (or base station) 704 may obtain the configuration of Cell B from the DU of Cell B. In case Cell A and Cell B belong to a different DU of a different gNB, gNB (or base station or CU) 704 of Cell A may obtain the configuration of Cell B from gNB (or base station or CU) 706 of Cell B. The LTM configuration of candidate Cell B may include an L1 measurement configuration.

At step 720, UE 702 confirms the RRC Reconfiguration by transmitting an RRCReconfiguration complete message.

At step 730, gNB (or base station) 704 to which Cell A belongs sends a PDCCH order to UE 702 in order to initiate a TA acquisition procedure with Cell B. The PDCCH order includes the information (e.g., random access preamble index, SSB index, UL carrier [SUL or NUL]) used to send a random access preamble to Cell B. Note that after transmitting the RRCReconfiguration complete message, UE 702 performs L1 measurements of Cell B and reports these to gNB (or base station) 704 to which Cell A belongs. Based on these measurements gNB 604 can identify an UL carrier and SSB index of Cell B to be included in the PDCCH order.

At step 740, UE 702 sends a random access preamble to Cell B so that gNB 706 to which Cell B belongs can calculate a TA value to be used by UE 702, e.g., if an LTM cell switch procedure is triggered to Cell B.

In one embodiment, in case Cell A and Cell B belong to a different DU of the same gNB, the DU of Cell B can determine the TA based on the received random access preamble and inform the DU of Cell A about the determined TA. In one embodiment, the DU of Cell B informs the DU of Cell A about the TA upon receiving the random access preamble. In another embodiment, the DU of Cell B informs the DU of Cell A about the TA upon receiving the request for such information from the DU of Cell A, wherein the DU of Cell A may request the information when the DU of Cell A determines to switch to Cell B.

In one embodiment, in case Cell A and Cell B belong to the same DU of the same gNB, the DU determines the TA based on the received random access preamble and informs the DU of Cell A about the determined TA.

In one embodiment, in case Cell A and Cell B belong to a different DU of a different gNB, the DU of Cell B can determine the TA based on the received random access preamble and inform the CU of Cell B about the determined TA. The CU of Cell B then sends this information to the CU of Cell A and the CU of Cell A informs this information to the DU of Cell A. In one embodiment, the DU of Cell B can determine the TA based on the received random access preamble and inform the DU of Cell A about the determined TA.

At step 750, gNB (or base station) 704 of cell A decides to execute a cell switch to a target cell and transmits a MAC CE triggering the cell switch by including the candidate configuration index of the target cell i.e., Cell B, TA of Cell B. In one embodiment, one or more TCI state identifiers (identifying joint/UL TCI state/DL TCI state) for each of multiple TRPs of Cell B can be included in the MAC CE triggering cell switch.

At step 760, UE 702 switches to the target cell B and applies the configuration indicated by candidate configuration index (At step 710 UE 702 may receive an LTM configuration of multiple candidate cells and each configuration is identified by a candidate configuration index). In one embodiment, UE 760 applies the TA received in the MAC CE triggering the cell switch for the TAG corresponding to the TAG ID (or TAG corresponding to the tag index) included in the early TA configuration and starts the corresponding TAT.

At step 770, UE 702 completes the LTM cell switch procedure by sending an RRCReconfigurationComplete message to target Cell B. In one embodiment, if target Cell B is not associated with multiple TAGs and a valid TA for the target Cell B is available (e.g., received in the MAC CE triggering the cell switch or UE 702 has estimated the TA) to UE 702, UE 702 does not initiate a RACH, performs RACH-less LTM cell switch, and transmits the first UL PUSCH transmission using a configured UL grant or dynamic UL grant. The first UL transmission includes the RRCReconfigurationComplete message. In one embodiment, if one uplink TCI state identifier is included in the MAC CE triggering the cell switch and target Cell B is associated with multiple TAGs and a valid TA for the TAG associated with the TCI state (identified by an uplink TCI state identifier) is available (e.g., received in the MAC CE triggering the cell switch or UE 702 has estimated the TA) to UE 702, UE 702 does not initiate a RACH, performs a RACH-less LTM cell switch, and transmits the first UL PUSCH transmission using a configured UL grant or dynamic UL grant. The first UL transmission includes the RRCReconfigurationComplete message. In one embodiment, if two uplink TCI state identifiers are included in the MAC CE triggering the cell switch and target Cell B is associated with multiple TAGs and a valid TA for the TAG associated with the TCI state identified by at least one uplink TCI state identifier is available (e.g., received in the MAC CE triggering the cell switch or UE has estimated the TA) to UE 702, UE 702 does not initiate a RACH, performs a RACH-less LTM cell switch and transmits the first UL PUSCH transmission using a configured UL grant or dynamic UL grant. The first UL transmission includes the RRCReconfigurationComplete message.

Although FIG. 7 illustrates one example procedure for lower layer triggered mobility to a cell supporting multiple TRPs/TAGs 700, various changes may be made to FIG. 7. For example, while shown as a series of steps, various steps in FIG. 7 could overlap, occur in parallel, occur in a different order, occur any number of times, be omitted, or replaced by other steps.

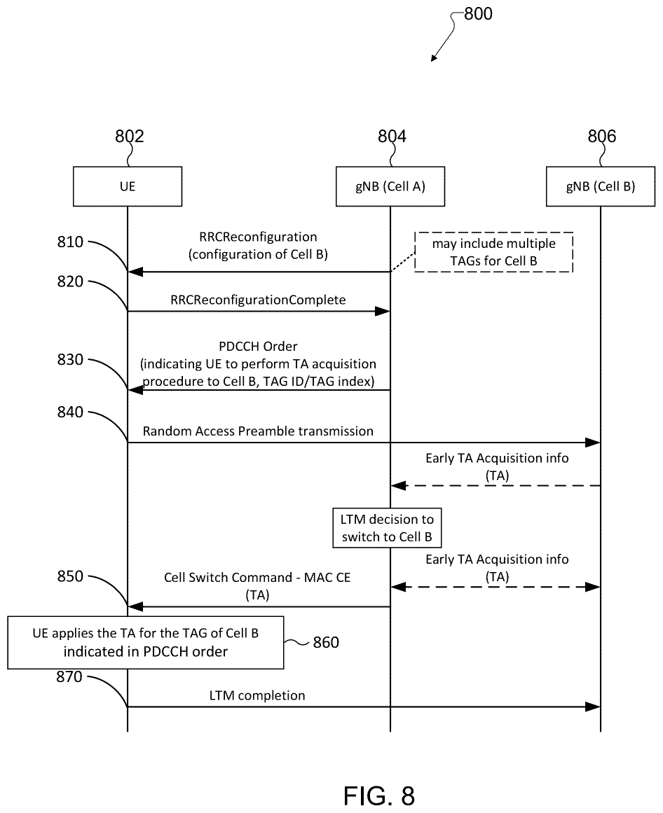

FIG. 8 illustrates another example procedure for lower layer triggered mobility to a cell supporting multiple TRPs/TAGs 800 according to embodiments of the present disclosure. An embodiment of the method illustrated in FIG. 7 is for illustration only. One or more of the components illustrated in FIG. 8 may be implemented in specialized circuitry configured to perform the noted functions or one or more of the components may be implemented by one or more processors executing instructions to perform the noted functions. Other embodiments of lower layer triggered mobility to a cell supporting multiple TRPs/TAGs could be used without departing from the scope of this disclosure.

In the example of FIG. 8, the process begins at step 810. At step 810, gNB (or base station) 804 of Cell A provides the LTM configuration of candidate Cell B to UE 802. Cell A is a serving cell. Cell B is associated with multiple TRPs/TAGs. In one embodiment, the number of multiple TRPs/TAGs can be 2. A TAG ID of each of the TAGs is included in the LTM configuration of candidate Cell B. One of these TAGS/TAG IDs can be referred as a first TAG (identified by a TAG index 0) and another can be referred as a second TAG (identified by a TAG index 1). The LTM configuration of candidate Cell B may include a TA acquisition configuration. The TA acquisition configuration includes RRC configuration information used to send a random access preamble to Cell B so that gNB 806 to which Cell B belongs can calculate a TA value to be used by UE 802, e.g., in case an LTM cell switch procedure is executed to Cell B. The LTM configuration of candidate Cell B may include a configuration of Cell B to be applied in case an LTM cell switch procedure is executed to Cell B. The LTM configuration of candidate Cell B may include a list of TCI states wherein each TCI state is associated to one of the TAGs of Cell B. In case Cell A and Cell B belong to a different DU of the same gNB, the gNB or base station may obtain the configuration of Cell B from the DU of Cell B. In case Cell A and Cell B belong to a different DU of different gNB, gNB (or base station or CU) 804 of Cell A may obtain the configuration of Cell B from gNB (or base station or CU) 806 of Cell B. The LTM configuration of candidate Cell B may include an L1 measurement configuration.

At step 820, UE 802 confirms the RRC Reconfiguration by transmitting an RRCReconfiguration complete message.

At step 830, gNB (or base station) 804 to which Cell A belongs sends a PDCCH order to UE 802 in order to initiate a TA acquisition procedure with Cell B. The PDCCH order includes the information (e.g., random access preamble index, SSB index, UL carrier [SUL or NUL]) used to send a random access preamble to Cell B. Note that after transmitting the RRCReconfiguration complete message, UE 802 performs L1 measurements of Cell B and reports these to gNB (or base station) 802 to which Cell A belongs. Based on these measurements gNB 804 can identify a UL carrier and SSB index of Cell B to be included in the PDCCH order. In one embodiment, a TAG ID/TAG index of TAG associated with early TA is included in the PDCCH order.

At step 840, UE 802 sends a random access preamble to Cell B so that gNB 806 to which Cell B belongs can calculate a TA value to be used by the UE, e.g., if an LTM cell switch procedure is triggered to Cell B.

In one embodiment, in case Cell A and Cell B belong to a different DU of the same gNB, the DU of Cell B can determine the TA based on the received random access preamble and inform the DU of Cell A about the determined TA. In one embodiment, the DU of Cell B informs the DU of Cell A about the TA upon receiving the random-access preamble. In another embodiment, the DU of Cell B informs the DU of Cell A about the TA upon receiving the request for such information from the DU of Cell A, wherein the DU of Cell A may request the information when the DU or Cell A determines to switch to Cell B.

In one embodiment, in case Cell A and Cell B belong to the same DU of the same gNB, the DU determines the TA based on the received random access preamble and informs the DU of Cell A about the determined TA.

In one embodiment, in case Cell A and Cell B belong to a different DU of a different gNB, the DU of Cell B can determine the TA based on the received random access preamble and inform the CU of Cell B about the determined TA. The CU of Cell B then sends this information to the CU of Cell A and the CU of Cell A informs this information to the DU of Cell A. In one embodiment, the DU of Cell B can determine the TA based on the received random access preamble and inform the DU of Cell A about the determined TA.

At step 850, gNB (or base station) 804 of cell A decides to execute a cell switch to a target cell and transmits a MAC CE triggering the cell switch by including the candidate configuration index of the target cell i.e., Cell B, TA of Cell B. In one embodiment, one or more TCI state identifiers (identifying joint/UL TCI state/DL TCI state) for each of multiple TRPs of Cell B can be included in the MAC CE triggering the cell switch.

At step 860, UE 802 switches to the target cell B and applies the configuration indicated by the candidate configuration index (At step 810 UE 802 may receive an LTM configuration of multiple candidate cells and each configuration is identified by a candidate configuration index). In one embodiment, UE 802 applies the TA received in the MAC CE triggering the cell switch for the TAG corresponding to the TAG ID (or TAG corresponding to the tag index) included in the PDCCH order and starts the corresponding TAT.

At step 870, UE 802 completes the LTM cell switch procedure by sending an RRCReconfigurationComplete message to target cell B. In one embodiment, if target cell B is not associated with multiple TAGs and a valid TA for the target cell B is available (e.g., received in the MAC CE triggering the cell switch or UE 802 has estimated the TA) to UE 802, UE 802 does not initiate a RACH, performs a RACH-less LTM cell switch, and transmits the first UL PUSCH transmission using a configured UL grant or dynamic UL grant. The first UL transmission includes the RRCReconfigurationComplete message. In one embodiment, if one uplink TCI state identifier is included in the MAC CE triggering the cell switch and target cell B is associated with multiple TAGs and a valid TA for the TAG associated with the TCI state (identified by an uplink TCI state identifier) is available (e.g., received in the MAC CE triggering the cell switch or UE 802 has estimated the TA) to UE 802, UE 802 does not initiate a RACH, performs a RACH-less LTM cell switch, and transmits the first UL PUSCH transmission using configured UL grant or dynamic UL grant. The first UL transmission includes the RRCReconfigurationComplete message. In one embodiment, if two uplink TCI state identifiers are included in the MAC CE triggering the cell switch and target cell B is associated with multiple TAGs and a valid TA for the TAG associated with the TCI state identified by at least one uplink TCI state identifier is available (e.g., received in the MAC CE triggering the cell switch or UE 802 has estimated the TA) to UE 802, UE 802 does not initiate a RACH, performs a RACH-less LTM cell switch, and transmits the first UL PUSCH transmission using a configured UL grant or dynamic UL grant. The first UL transmission includes the RRCReconfigurationComplete message.

Although FIG. 8 illustrates one example procedure for lower layer triggered mobility to a cell supporting multiple TRPs/TAGs 800, various changes may be made to FIG. 8. For example, while shown as a series of steps, various steps in FIG. 8 could overlap, occur in parallel, occur in a different order, occur any number of times, be omitted, or replaced by other steps.

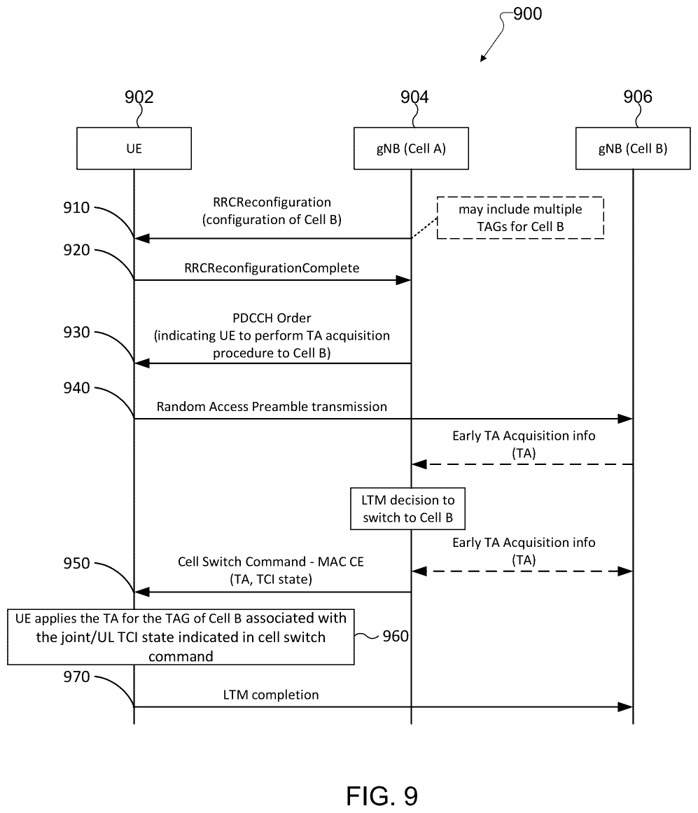

FIG. 9 illustrates another example procedure for lower layer triggered mobility to a cell supporting multiple TRPs/TAGs 900 according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of lower layer triggered mobility to a cell supporting multiple TRPs/TAGs could be used without departing from the scope of this disclosure.

In the example of FIG. 9, the process begins at step 910. At step 910, gNB (or base station) 904 of Cell A provides the LTM configuration of candidate Cell B to UE 902. Cell A is a serving cell. Cell B is associated with multiple TRPs/TAGs. In one embodiment, the number of multiple TRPs/TAGs can be 2. A TAG ID of each of the TAGs is included in the LTM configuration of candidate Cell B. One of these TAGS/TAG IDs can be referred to as a first TAG (identified by a TAG index 0) and another can be referred as a second TAG (identified by a TAG index 1). The LTM configuration of candidate Cell B may include a TA acquisition configuration. The TA acquisition configuration includes RRC configuration information used to send a random access preamble to Cell B so that gNB 906 to which Cell B belongs can calculate a TA value to be used by UE 902, e.g., in case an LTM cell switch procedure is executed to Cell B. The LTM configuration of candidate Cell B may include a configuration of Cell B to be applied in case an LTM cell switch procedure is executed to Cell B. The LTM configuration of candidate Cell B may include a list of TCI states wherein each TCI state is associated to one of the TAGs of Cell B. In case Cell A and Cell B belong to a different DU of the same gNB, the gNB or base station may obtain the configuration of Cell B from the DU of Cell B. In case Cell A and Cell B belong to a different DU of a different gNB, gNB (or base station or CU) 904 of Cell A may obtain the configuration of Cell B from gNB (or base station or CU) 906 of Cell B. The LTM configuration of candidate Cell B may include an L1 measurement configuration.

At step 920, UE 902 confirms the RRC Reconfiguration by transmitting an RRCReconfiguration complete message.

At step 930, gNB (or base station) 904 to which Cell A belongs sends a PDCCH order to UE 902 in order to initiate a TA acquisition procedure with Cell B. The PDCCH order includes the information (e.g., random access preamble index, SSB index, UL carrier [SUL or NUL]) required to send a random access preamble to Cell B. Note that after transmitting the RRCReconfiguration complete message, UE 902 performs L1 measurements of Cell B and reports these to gNB (or base station) 904 to which Cell A belongs. Based on these measurements gNB 904 can identify an UL carrier and SSB index of Cell B to be included in the PDCCH order.

At step 940, UE 902 sends a random access preamble to Cell B so that gNB 906 to which Cell B belongs can calculate a TA value to be used by UE 902, e.g., if an LTM cell switch procedure is triggered to Cell B.

In one embodiment, in case Cell A and Cell B belong to a different DU of the same gNB, the DU of Cell B can determine the TA based on the received random access preamble and inform the DU of Cell A about the determined TA. In one embodiment, the DU of Cell B informs the DU of Cell A about the TA upon receiving the random access preamble. In another embodiment, the DU of Cell B informs the DU of Cell A about the TA upon receiving the request for such information from the DU of Cell A, wherein the DU of Cell A may request the information when the DU of Cell A determines to switch to Cell B.

In one embodiment, in case Cell A and Cell B belong to the same DU of the same gNB, the DU determines the TA based on the received random access preamble and informs the DU of Cell A about the determined TA.

In one embodiment, in case Cell A and Cell B belong to a different DU of a different gNB, the DU of Cell B can determine the TA based on the received random access preamble and inform the CU of Cell B about the determined TA. The CU of Cell B then sends this information to the CU of Cell A and the CU of Cell A informs this information to the DU of Cell A.

At step 950, the gNB or base station of Cell A decides to execute cell switch to a target cell and transmits a MAC CE triggering the cell switch by including the candidate configuration index of the target cell i.e., Cell B, TA of Cell B.

At step 960, UE 902 switches to the target cell B and applies the configuration indicated by the candidate configuration index (At step 910 UE 902 may receive an LTM configuration of multiple candidate cells and each configuration is identified by the candidate configuration index). In an embodiment, UE applies the TA received in the MAC CE triggering the cell switch for the TAG which is configured as associated with the joint/UL TCI state indicated in MAC CE triggering the cell switch and starts the corresponding TAT. The mapping of TCI states to TAGS is received in step 910. The MAC CE may include a TCI state ID field. The LTM configuration of target cell B received in step 910 may include a field/parameter unifiedTCI-State Type. unifiedTCI-State Type can be set to one of ‘separate’ or ‘joint’. If unifiedTCI-State Type is set to ‘joint’, the TCI state ID field indicates a joint TCI state. If unifiedTCI-State Type is set to ‘separate’, the TCI state ID field indicates a DL TCI state. The MAC CE may include a UL TCI state ID field. The LTM configuration of target cell B received in step 910 may include a field/parameter unifiedTCI-State Type. unifiedTCI-State Type can be set to one of ‘separate’ or ‘joint’. If unifiedTCI-State Type is set to ‘separate’, the UL TCI state ID field indicates an UL TCI state.

In one embodiment, if unifiedTCI-State Type is set to ‘separate’ in the LTM configuration of target cell B, UE 902 applies the TA received in the MAC CE triggering the cell switch for the TAG which is configured as associated with the UL TCI state (i.e., TCI state indicated by the UL TCI state ID field) indicated in the MAC CE triggering the cell switch and starts the corresponding TAT. A list of UL TCI states is configured by the list ltm-UL-TCI-StatesToAddModList in the LTM configuration of target cell B. The UL TCI state in list is identified by TCI-UL-StateId in ltm-UL-TCI-StatesToAddModList. The TAG (e.g., first or second TAG) associated with the UL TCI state is also indicated in ltm-UL-TCI-StatesToAddModList. The UL TCI state ID is set to TCI-UL-StateId of an UL TCI State.

In one embodiment, if unifiedTCI-State Type is set to ‘joint’ in the LTM configuration of target cell B, UE 902 applies the TA received in the MAC CE triggering the cell switch for the TAG which is configured as associated with the joint TCI state (i.e., TCI state indicated by the TCI state ID field) indicated in the MAC CE triggering the cell switch and starts the corresponding TAT. A list of joint TCI states is configured by the list ltm-DL-OrJointTCI-StateToAddModList in the LTM configuration of target cell B. Each joint TCI state in the list is identified by TCI-StateId in ltm-DL-OrJointTCI-StateToAddModList. The TAG (e.g., first or second TAG) associated with the joint TCI state is also in ltm-DL-OrJointTCI-StateToAddModList. The TCI state ID is set to a TCI-StateId of a joint TCI State.

In one embodiment, if an UL TCI state ID field is included in the MAC CE triggering the cell switch, UE 902 applies the TA received in the MAC CE triggering cell switch for the TAG which is configured as associated with the UL TCI state (i.e., the TCI state indicated by the UL TCI state ID field) indicated in the MAC CE triggering the cell switch and starts the corresponding TAT (i.e., the TAT for the TAG associated with the UL TCI state [i.e., the TCI state indicated by the UL TCI state ID field]).

In one embodiment, if the UL TCI state ID field is not included in the MAC CE triggering the cell switch, UE 902 applies the TA received in MAC CE triggering cell switch for the TAG which is configured as associated with the joint TCI state (i.e., the TCI state indicated by the TCI state ID field in the MAC CE triggering the cell switch) indicated in the MAC CE triggering the cell switch and starts the corresponding TAT (i.e. the TAT for the TAG associated with the UL TCI state [i.e., the TCI state indicated by the TCI state ID field in the MAC CE triggering the cell switch]).

At step 970, UE 902 completes the LTM cell switch procedure by sending an RRCReconfigurationComplete message to target cell B. In one embodiment, if target cell B is not associated with multiple TAGs and a valid TA for the target cell B is available (e.g., received in the MAC CE triggering the cell switch or UE 902 has estimated the TA) to UE 902, UE 902 does not initiate a RACH, perform, a RACH-less LTM cell switch, and transmits the first UL PUSCH transmission using a configured UL grant or dynamic UL grant. The first UL transmission includes the RRCReconfigurationComplete message. In one embodiment, if one uplink TCI state identifier is included in the MAC CE triggering the cell switch and target cell B is associated with multiple TAGs and a valid TA for the TAG associated with the TCI state (identified by an uplink TCI state identifier) is available (e.g., received in the MAC CE triggering the cell switch or UE 902 has estimated the TA) to UE 902, UE 902 does not initiate a RACH, performs a RACH-less LTM cell switch, and transmits the first UL PUSCH transmission using a configured UL grant or dynamic UL grant. The first UL transmission includes the RRCReconfigurationComplete message.

In one embodiment, if two uplink TCI state identifiers are included in the MAC CE triggering the cell switch and target cell B is associated with multiple TAGs and a valid TA for the TAG associated with the TCI state identified by at least one uplink TCI state identifier is available (e.g., received in the MAC CE triggering the cell switch or UE 902 has estimated the TA) to UE 902, UE 902 does not initiate RACH, perform, a RACH-less LTM cell switch, and transmits the first UL PUSCH transmission using a configured UL grant or dynamic UL grant. The first UL transmission includes the RRCReconfigurationComplete message.

Although FIG. 9 illustrates one example procedure for lower layer triggered mobility to a cell supporting multiple TRPs/TAGs 900, various changes may be made to FIG. 9. For example, while shown as a series of steps, various steps in FIG. 9 could overlap, occur in parallel, occur in a different order, occur any number of times, be omitted, or replaced by other steps.

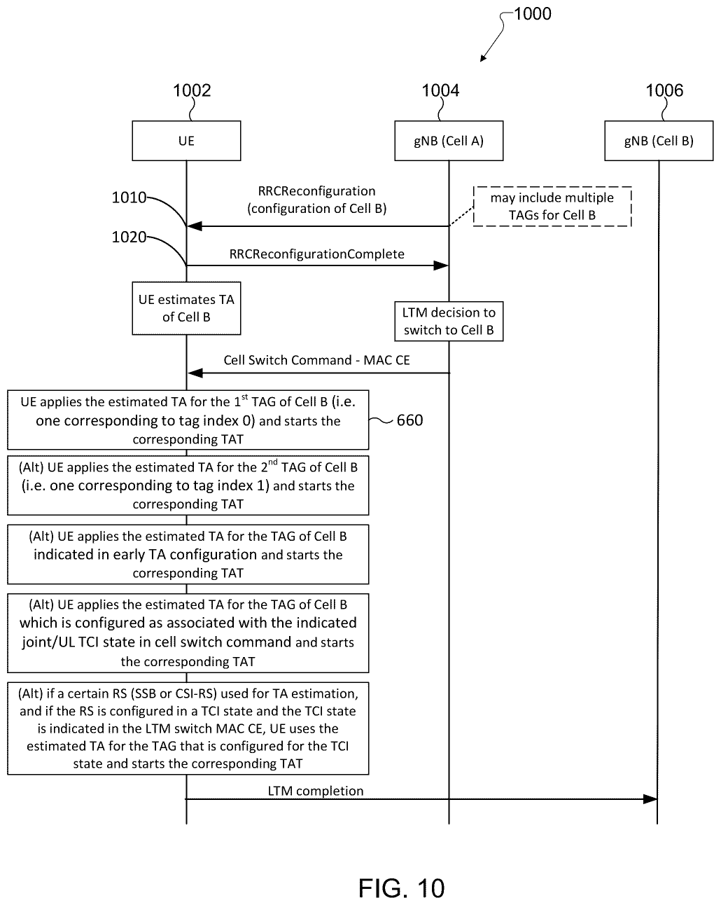

FIG. 10 illustrates another example procedure for lower layer triggered mobility to a cell supporting multiple TRPs/TAGs 1000 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of lower layer triggered mobility to a cell supporting multiple TRPs/TAGs could be used without departing from the scope of this disclosure.

In the example of FIG. 10, the process begins at step 1010. At step 1010, gNB (or base station) 1004 of Cell A provides the LTM configuration of candidate Cell B to UE 1002. Cell A is a serving cell. Cell B is associated with multiple TRPs/TAGs. In one embodiment, the number of multiple TRPs/TAGs can be 2. A TAG ID of each of the TAGs is included in the LTM configuration of candidate Cell B. One of these TAGS/TAG IDs can be referred to as a first TAG (identified by a TAG index 0) and another can be referred to as a second TAG (identified by a TAG index 1). The LTM configuration of candidate Cell B may include a TA acquisition configuration. The TA acquisition configuration includes RRC configuration information used to send a random access preamble to Cell B so that the gNB 1006 to which Cell B belongs can calculate a TA value to be used by UE 1002, e.g., in case an LTM cell switch procedure is executed to Cell B. The LTM configuration of candidate Cell B may include a configuration of Cell B to be applied in case an LTM cell switch procedure is executed to Cell B. The LTM configuration of candidate Cell B may include a list of TCI states wherein each TCI state is associated to one of the TAGs of Cell B. In case Cell A and Cell B belong to a different DU of the same gNB, gNB (or base station) 1004 may obtain the configuration of Cell B from the DU of Cell B. In case Cell A and Cell B belong to a different DU of different gNB, gNB (or base station or CU) 1004 of Cell A may obtain the configuration of Cell B from gNB (or base station or CU) 1006 of Cell B. The LTM configuration of candidate Cell B may include an L1 measurement configuration.

At step 1020, UE 1004 confirms the RRC Reconfiguration by transmitting an RRCReconfiguration complete message.

At step 1030, UE 1002 estimates the TA of cell B based on the difference between a DL signal arrival at Cell A and Cell B and the TA of Cell A.

At step 1040, gNB (or base station) 1004 of cell A decides to execute a cell switch to a target cell and transmits a MAC CE triggering the cell switch by including the candidate configuration index of the target cell i.e., Cell B.

At step 1050, UE 1002 switches to the target cell B and applies the configuration indicated by the candidate configuration index (at step 1010 UE 1002 may receive and LTM configuration of multiple candidate cells and each configuration is identified by a candidate configuration index).

In one embodiment, UE 1002 applies the estimated TA for the first TAG of Cell B (i.e., the one corresponding to tag index 0) and starts the corresponding TAT. At step 1060, UE 1002 does not initiate a RACH, performs a RACH-less LTM switch, and transmits the first UL PUSCH transmission using a configured UL grant or dynamic UL grant. The first UL transmission includes an RRCReconfigurationComplete message.

In another embodiment, UE 1002 applies the estimated TA for the second TAG of Cell B (i.e., the one corresponding to tag index 1) and starts the corresponding TAT. At step 1060, UE 1002 does not initiate a RACH, performs a RACH-less LTM cell switch, and transmits the first UL PUSCH transmission using a configured UL grant or dynamic UL grant. The first UL transmission includes an RRCReconfigurationComplete message.

In another embodiment, UE 1002 applies the estimated TA for the TAG of Cell B indicated in the early TA configuration and starts the corresponding TAT. At step 1060, UE 1002 does not initiate a RACH, performs a RACH-less LTM cell switch, and transmits the first UL PUSCH transmission using a configured UL grant or dynamic UL grant. The first UL transmission includes a RRCReconfigurationComplete message.

In another embodiment, UE 1002 applies the estimated TA for the TAG of Cell B which is configured as associated with the indicated joint/UL TCI state in the cell switch command and starts the corresponding TAT. At step 1060, UE does not initiate a RACH, performs a RACH-less LTM cell switch, and transmits the first UL PUSCH transmission using a configured UL grant or dynamic UL grant. The first UL transmission includes a RRCReconfigurationComplete message.

In another embodiment, if a certain RS (SSB or CSI-RS) used for a TA estimation, and if the RS is configured in a TCI state and the TCI state is indicated in the LTM switch MAC CE, UE 1002 uses the estimated TA for the TAG that is configured for the TCI state and starts the corresponding TAT. At step 1060, UE does not initiate a RACH, perform RACH-less LTM cell switch, and transmits the first UL PUSCH transmission using a configured UL grant or dynamic UL grant. The first UL transmission includes a RRCReconfigurationComplete message. Otherwise, at step 1060, UE 1002 may initiate a RACH towards the target Cell B.

Although FIG. 10 illustrates one example procedure for lower layer triggered mobility to a cell supporting multiple TRPs/TAGs 1000, various changes may be made to FIG. 10. For example, while shown as a series of steps, various steps in FIG. 10 could overlap, occur in parallel, occur in a different order, occur any number of times, be omitted, or replaced by other steps.

A MAC CE triggering a cell switch indicating for a UE to apply the TA of a source cell during and LTM cell switch to an LTM candidate cell with multiple TRPs. In one embodiment, at step 1, the gNB or base station of a serving cell (cell A), such as BS 102 of FIG. 1, decides to execute a cell switch to a target cell, and transmits a MAC CE triggering the cell switch by including the candidate configuration index of the target cell i.e., Cell B, to a UE, such as UE 116 of FIG. 1. In one embodiment, the MAC CE triggering the cell switch may indicate for the UE to apply the TA of Cell A. In one embodiment one or more TCI state identifiers (identifying joint/UL TCI state/DL TCI state) for each of multiple TRPs of Cell B can be included in the MAC CE triggering cell switch.

At step 2, the UE switches to the target cell B and applies the configuration indicated by the candidate configuration index (At step 1 the UE may receive an LTM configuration of multiple candidate cells, and each configuration is identified by a candidate configuration index).

The MAC CE triggering the cell switch indicates for the UE to apply the TA of Cell A. The UE performs the operation as follows:

Case 1: Cell A is associated with one TAG. Cell B is associated with one TAG. In this case the UE applies the TA of Cell A for UL transmission to Cell B. The UL transmission(s) are QCLed with the joint/UL TCI state indicated in the MAC CE triggering the cell switch.

Case 2: Cell A is associated with one TAG. Cell B is associated with two TAGs. In this case a UL transmission QCLed with a joint/UL TCI state which is associated with a TAG that is the same as the TAG of Cell A, and the UE applies the TA of Cell A. The UE applies the TA of Cell A to UL transmissions associated with same TAG as that of Cell A.

In one embodiment, if one joint/uplink TCI state identifier is included in the MAC CE triggering the cell switch and target cell B is associated with multiple TAGs and a TAG associated with the TCI state (identified by an uplink TCI state identifier) is the same as the TAG of Cell A, the UE does not initiate a RACH, performs RACH-less LTM cell switch, and transmits the first UL PUSCH transmission using a configured UL grant or dynamic UL grant. The first UL transmission includes an RRCReconfigurationComplete message.

In one embodiment, if one joint/uplink TCI state identifier is included in the MAC CE triggering the cell switch and target cell B is associated with multiple TAGs and the TAG associated with the TCI state (identified by an uplink TCI state identifier) is not the same as the TAG of Cell A, the UE initiates a RACH towards Cell B.

In one embodiment, if two joint/uplink TCI state identifiers are included in the MAC CE triggering the cell switch and target cell B is associated with multiple TAGs and a TAG associated with the TCI state identified by at least one uplink TCI state identifier is the same as the TAG of cell A, the UE does not initiate a RACH, performs a RACH-less LTM cell switch, and transmits the first UL PUSCH transmission using a configured UL grant or dynamic UL grant. The first UL transmission includes an RRCReconfigurationComplete message.

Case 3: Cell A is associated with two TAGs. Cell B is associated with one TAG. In this case the UE applies the TA of Cell A corresponding to the TAG of Cell B for UL transmission to Cell B. The UL transmission(s) are QCLed with the joint/UL TCI state indicated in the MAC CE triggering the cell switch.

Case 4: Cell A is associated with two TAGs. Cell B is associated with two TAGs. In this case UL transmission is QCLed with a joint/UL TCI state which is associated with a TAG that is the same as the TAG of Cell A, and the UE applies the TA of Cell A corresponding to that TAG.

In one embodiment, if one joint/uplink TCI state identifier is included in the MAC CE triggering the cell switch and target cell B is associated with multiple TAGs and the TAG associated with the TCI state (identified by an uplink TCI state identifier) is the same as the TAG of Cell A, the UE does not initiate a RACH, perform, a RACH-less cell switch, and transmits the first UL PUSCH transmission using a configured UL grant or dynamic UL grant. The first UL transmission includes an RRCReconfigurationComplete message.

In one embodiment, if two joint/uplink TCI state identifiers are included in the MAC CE triggering the cell switch and target cell B is associated with multiple TAGs and the TAG associated with the TCI state identified by at least one uplink TCI state identifier is the same as the TAG of cell A, the UE does not initiate a RACH, performs a RACH-less LTM cell switch, and transmits the first UL PUSCH transmission using a configured UL grant or dynamic UL grant. The first UL transmission includes the RRCReconfigurationComplete message.

In existing wireless communication systems supporting LTM, a UE receives an RRCReconfiguration message including an RRCReconfiguration of one or more candidate LTM cells, the UE receives an LTM cell switch command MAC CE for a candidate LTM cell, and the UE applies the RRCReconfiguration of the indicated candidate LTM cell. The RRCReconfiguration includes dedicatedSIB1-Delivery. The UE performs actions to process SIB1 upon reception of the SIB1. This leads to generation and submission of an SI request. Additionally, the RRCReconfiguration message includes the ltm-Config: UE performs the LTM configuration procedure. This leads to generation and submission of an ReconfigurationComplete message. However, according to the above operation, the ReconfigurationComplete will be delayed because of the SI request message in SRB buffer. The present disclosure provides procedures to overcome this issue.

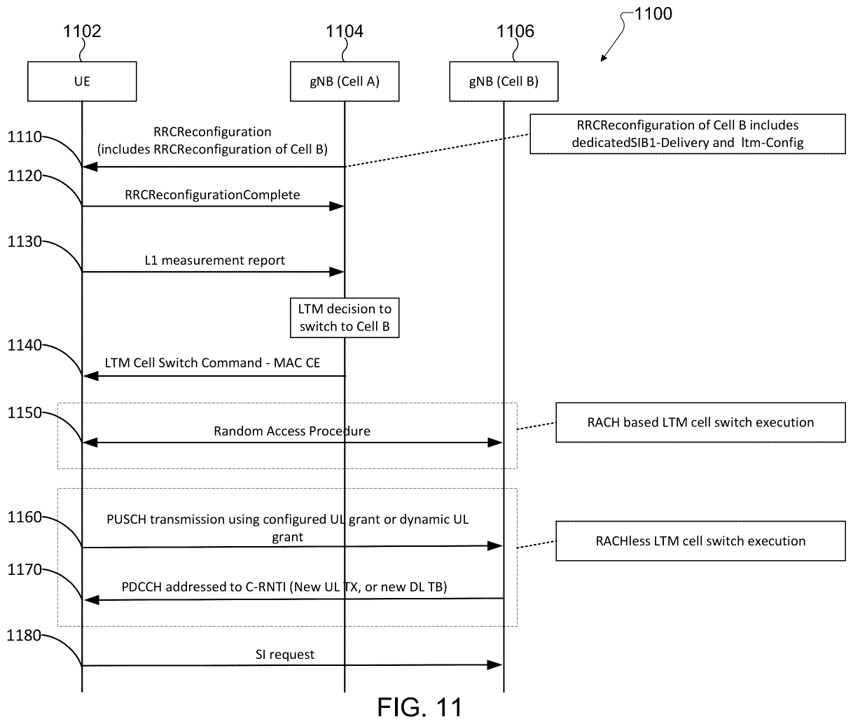

FIG. 11 illustrates an example procedure for lower layer triggered mobility 1100 according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of lower layer triggered mobility to a cell supporting multiple TRPs/TAGs could be used without departing from the scope of this disclosure.

In the example of FIG. 11, the process begins at step 1110. At step 1110 gNB (or base station) 1102 of Cell A provides the configuration of LTM candidate Cell B to UE 1102. The configuration of LTM candidate Cell B may include an L1 measurement configuration. Cell A is a serving cell and belongs to an MCG, Cell B is a candidate PCell or SpCell. An RRCReconfiguration IE for Cell B is included in the RRCReconfiguration message received from gNB (or base station) 1104 of Cell A. The RRCReconfiguration IE for Cell B includes dedicatedSIB1-Delivery and ltm-Config IEs.

At step 1120, UE 1102 confirms the RRC Reconfiguration received from gNB (or base station) 1104 of Cell A by transmitting an RRCReconfiguration complete message.

At step 1130, after transmitting the RRCReconfiguration complete message, UE 1102 performs L1 measurements of Cell B and reports these to gNB (or base station) 1102 to which Cell A belongs.

At step 1140, based on L1 measurements, gNB (or base station) 1104 of cell A decides to execute an LTM cell switch to a target cell i.e., Cell B and transmits a MAC CE triggering the LTM cell switch by including the candidate configuration index of the target cell i.e., Cell B.

At step 150, the UE switches to the target cell B and applies the configuration (i.e., RRCReconfiguration IE for Cell B received in step 1) indicated by candidate configuration index (At step 1 UE may receive LTM configuration of multiple candidate cells and each configuration is identified by candidate configuration index).

In one embodiment, if the applied RRCReconfiguration is associated to the MCG (i.e., target cell B belongs to the MCG) and includes ltm-Config and dedicatedSIB1-Delivery, the UE initiates (if needed) the request to acquire required SIBs of Cell B (step 1160), only after the LTM execution towards the target SpCell is successfully completed. dedicatedSIB1-Delivery includes the SIB1 of cell B and indicates which SIBs of Cell B are periodically broadcasted and which are not periodically broadcasted. For SIBs not periodically broadcasted and needed in the RRC_CONNECTED state, the UE may send an SI request message to Cell B. In this embodiment, the UE processes the dedicatedSIB1-Delivery before ltm-Config. The UE performs the random access procedure towards the target cell B, if the UE does not have a valid TA of the target cell. The UE completes the LTM cell switch procedure by sending an RRCReconfigurationComplete message to target cell B. If the UE has performed an RA procedure the UE considers that the LTM execution is successfully completed when the random access procedure is successfully completed. For RACH-less LTM, the UE considers that the LTM execution is successfully completed when the UE determines that the network has successfully received its first UL data (i.e., a PUSCH transmission using a configured UL grant or dynamic UL grant). The UE determines a successful reception of its first UL data by receiving a PDCCH addressing the UE's C-RNTI in the target cell, which schedules a new transmission (e.g., a new UL transmission or new DL transport block/transmission) following the first UL data.

In an alternate embodiment if RRCReconfiguration is associated to the MCG and includes ltm-Config and dedicatedSIB1-Delivery, the UE processes ltm-Config before processing dedicatedSIB1-Delivery in the applied RRCReconfiguration

Although FIG. 11 illustrates one example procedure for lower layer triggered mobility, various changes may be made to FIG. 11. For example, while shown as a series of steps, various steps in FIG. 11 could overlap, occur in parallel, occur in a different order, occur any number of times, be omitted, or replaced by other steps.

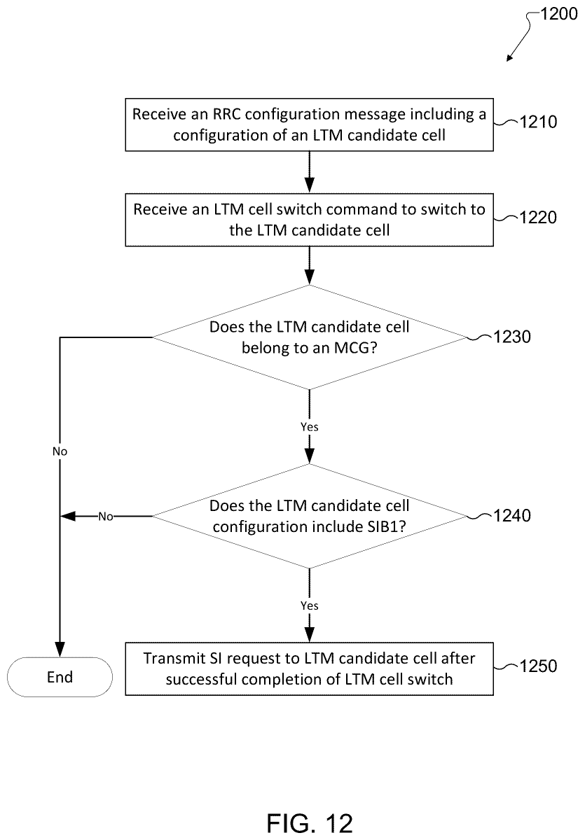

FIG. 12 illustrates an example method of lower layer triggered mobility to a cell supporting multiple TRPs 1200 according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of lower layer triggered mobility to a cell supporting multiple TRPs could be used without departing from the scope of this disclosure.

In the example of FIG. 12, the method begins at step 1210. At step 1210, a UE, such as UE 116 of FIG. 1 receiving an RRC reconfiguration message including a configuration of an LTM candidate cell. At step 1220, the UE receives an LTM cell switch command instructing the UE to perform an LTM cell switch to the LTM candidate cell. At step 1230, the UE determines whether the LTM candidate cell belongs to an MCG. At step 1240, the UE determines whether the configuration of the LTM candidate cell includes SIB1. If the LTM candidate cell belongs to the MCG and the configuration of the LTM candidate cell includes the SIB1, the method proceeds to step 1250. Otherwise, the method ends. At step 1250, the UE transmits an SI request to the LTM candidate cell after the LTM cell switch to the LTM candidate cell is successfully completed.

Although FIG. 12 illustrates one example method of lower layer triggered mobility to a cell supporting multiple TRPs 1200, various changes may be made to FIG. 12. For example, while shown as a series of steps, various steps in FIG. 12 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive a radio resource control (RRC) reconfiguration message including a configuration of a lower layer triggered mobility (LTM) candidate cell; and
receive an LTM cell switch command instructing the UE to perform an LTM cell switch to the LTM candidate cell; and
a processor operably coupled to the transceiver, the processor configured to:
determine whether the LTM candidate cell belongs to a master cell group (MCG); and
determine whether the configuration of the LTM candidate cell includes a system information block 1 (SIB1),
wherein the transceiver is further configured to, when the LTM candidate cell belongs to the MCG and the configuration of the LTM candidate cell includes the SIB1, transmit a system information (SI) request to the LTM candidate cell after the LTM cell switch to the LTM candidate cell is successfully completed.

2. The UE of claim 1, wherein:
the transceiver is further configured to:
upon receiving the LTM cell switch command, transmit, on a physical uplink shared channel (PUSCH), a first transmission to the LTM candidate cell; and
after transmission of the first transmission, receive, on a physical downlink control channel (PDCCH), downlink control information (DCI) addressed to a Cell Radio Network Temporary Identifier (C-RNTI) assigned to the UE scheduling a second transmission; and
the processor is further configured to consider that the LTM cell switch to the LTM candidate cell is successfully completed when the UE receives the DCI scheduling the second transmission.

3. The UE of claim 2, wherein the second transmission scheduled by the DCI addressed to the C-RNTI assigned to the UE is an uplink (UL) transmission.

4. The UE of claim 2, wherein the second transmission scheduled by the DCI addressed to the C-RNTI assigned to the UE is a downlink (DL) transmission.

5. The UE of claim 1, wherein the processor is further configured to, upon receiving the LTM cell switch command:
determine whether the UE has a valid timing advance (TA) of the LTM candidate cell; and
based on the determination whether the UE has the valid TA of the LTM candidate cell, select an LTM cell switch procedure.

6. The UE of claim 5, wherein:
the transceiver is further configured to:
upon a determination that the UE has the valid TA of the LTM candidate cell, transmit, on a physical uplink shared channel (PUSCH), a first transmission to the LTM candidate cell; and
after transmission of the first transmission, receive, on a physical downlink control channel (PDCCH), downlink control information (DCI) addressed to a Cell Radio Network Temporary Identifier (C-RNTI) assigned to the UE scheduling a second transmission; and
the processor is further configured to consider that the LTM cell switch to the LTM candidate cell is successfully completed when the UE receives the DCI scheduling the second transmission.

7. The UE of claim 5, wherein the processor is further configured to, upon a determination that the UE does not have a valid TA of the LTM candidate cell, initiate a random access (RA) procedure towards the LTM candidate cell.

8. The UE of claim 7, wherein the processor is further configured to consider that the LTM cell switch to the LTM candidate cell is successfully completed when the RA procedure is successfully completed.

9. The UE of claim 1, wherein the processor is further configured to, when the LTM candidate cell belongs to the MCG and the configuration of the LTM candidate cell includes the SIB1, process the SIB1 before processing the configuration of the LTM candidate cell.

10. The UE of claim 1, wherein the processor is further configured to, when the LTM candidate cell belongs to the MCG and the configuration of the LTM candidate cell includes the SIB1, process the configuration of the LTM candidate cell before processing the SIB1.

11. A method of operating a user equipment (UE), the method comprising:
receiving a radio resource control (RRC) reconfiguration message including a configuration of a lower layer triggered mobility (LTM) candidate cell;
receiving an LTM cell switch command instructing the UE to perform an LTM cell switch to the LTM candidate cell;
determining whether the LTM candidate cell belongs to a master cell group (MCG);
determining whether the configuration of the LTM candidate cell includes a system information block 1 (SIB1); and
when the LTM candidate cell belongs to the MCG and the configuration of the LTM candidate cell includes the SIB1, transmitting a system information (SI) request to the LTM candidate cell after the LTM cell switch to the LTM candidate cell is successfully completed.

12. The method of claim 11, further comprising:
upon receiving the LTM cell switch command, transmitting, on a physical uplink shared channel (PUSCH), a first transmission to the LTM candidate cell;
after transmission of the first transmission, receiving, on a physical downlink control channel (PDCCH), downlink control information (DCI) addressed to a Cell Radio Network Temporary Identifier (C-RNTI) assigned to the UE scheduling a second transmission; and
considering that the LTM cell switch to the LTM candidate cell is successfully completed when the UE receives the DCI scheduling the second transmission.

13. The method of claim 12, wherein the second transmission scheduled by the DCI addressed to the C-RNTI assigned to the UE is an uplink (UL) transmission.

14. The method of claim 12, wherein the second transmission scheduled by the DCI addressed to the C-RNTI assigned to the UE is a downlink (DL) transmission.

15. The method of claim 11, further comprising:
determining whether the UE has a valid timing advance (TA) of the LTM candidate cell; and
based on the determination whether the UE has the valid TA of the LTM candidate cell, selecting an LTM cell switch procedure.

16. The method of claim 15, further comprising:
upon a determination that the UE has the valid TA of the LTM candidate cell, transmitting, on a physical uplink shared channel (PUSCH), a first transmission to the LTM candidate cell;
after transmission of the first transmission, receiving, on a physical downlink control channel (PDCCH), downlink control information (DCI) addressed to a Cell Radio Network Temporary Identifier (C-RNTI) assigned to the UE scheduling a second transmission; and
considering that the LTM cell switch to the LTM candidate cell is successfully completed when the UE receives the DCI scheduling the second transmission.

17. The method of claim 15, further comprising, upon a determination that the UE does not have a valid TA of the LTM candidate cell, initiating a random access (RA) procedure towards the LTM candidate cell.

18. The method of claim 17, further comprising considering that the LTM cell switch to the LTM candidate cell is successfully completed when the RA procedure is successfully completed.

19. The method of claim 11, further comprising, when the LTM candidate cell belongs to the MCG and the configuration of the LTM candidate cell includes the SIB1, processing the SIB1 before processing the configuration of the LTM candidate cell.

20. The method of claim 11, further comprising, when the LTM candidate cell belongs to the MCG and the configuration of the LTM candidate cell includes the SIB1, processing the configuration of the LTM candidate cell before processing the SIB1.
